(19) United States
(12) Patent Application Publication
(10) Pub. No.: US 2007/0057954 A1
(43) Pub. Date: Mar. 15, 2007

(54) Image input device and solid-state image pickup element

(76) Inventors: Kunihiro Imamura, Kyoto (JP); Toshiya Fujii, Shiga (JP); Takumi Yamaguchi, Kyoto (JP); Takahiko Murata, Osaka (JP); Yoshihisa Shimazu, Kyoto (JP)

Correspondence Address: MCDERMOTT WILL & EMERY LLP, 600 13TH STREET, N.W., WASHINGTON, DC, 20005-3096, US

(21) Appl. No.: 11/517,353

(22) Filed: Sep. 8, 2006

(30) Foreign Application Priority Data
Sep. 9, 2005 (JP) 2005-262004

(51) Int. Cl. G09G 5/39

(52) U.S. Cl. 345/532

(57) ABSTRACT

The solid-state image pickup element comprises a filter film made of a single-layer inorganic material which exhibits a maximum value at a specific wavelength on transmission spectra of incident light in accordance with a film thickness thereof, and a photoelectrical conversion part for generating a signal charge in accordance with light quantity of the incident light transmitted through the filter film. For the filter film, a number of the filter films of at least two kinds having different film thickness is provided, and a number of the filter films are arranged in parallel based on a prescribed arrangement. Image pickup signals outputted from the solid-state image pickup element are signal-processed by a signal processor. The signal processor generates at least one of the signals that correspond to a luminance signal, a color signal, a color difference signal, and light quantity of incident light by applying color conversion processing on the image pickup signal in accordance with the prescribed arrangement.

### BACKGROUND OF THE INVENTION

1. Field of the Invention

The present invention relates to an image input device and a solid-state image pickup element and, more particularly, to a technique which makes the device smaller in size and highly reliable, so as to obtain desired video signals as well.

Recently, there has been an ever-increasing request for reducing the size of solid-state image pickup elements, for example, in accordance with the wide diffusion of portable telephones to which a digital camera is loaded. In the solid-state image pickup element, a color separation filter is used for separating incident light into three primary colors. Conventionally, organic materials such as pigments have been used as the materials of the color separation filter. However, inorganic materials are used these days.

As the color separation filter using an inorganic material, there is a color separation filter using a multilayer interference film, for example, as shown in Japanese Disclosed Patent Literature (Japanese Unexamined Patent Publication 5-45514: FIG. 12). The color separation filter using the inorganic material is easier to reduce its size compared to those using the organic material. Thus, an active development has been advanced for applying it to a solid-state imaging device.

However, the color separation filter using the inorganic material has a following issue. That is, since the color separation filter of the solid-state image pickup element is constituted with a single-layer inorganic material, light transmission characteristic is realized through interference and absorption when it is tried to achieve it by adjusting the film thickness. Therefore, as the film thickness increases, the wavelength indicating the maximum value in the transmission spectrum becomes shifted to the long wave side, which becomes the completely different light transmission characteristic from that of primary- or complementary-color filter that has been conventionally used in general.

When conventional image processing that generates video signals from the primary- or complementary-color sensor is applied to such case, it is not possible to obtain the desired video signals. This is because the light transmission characteristic of the color separation filter using the single-layer inorganic material is remarkably different from that of the conventional primary- or complementary-color separation filter.

### SUMMARY OF THE INVENTION

The main object of the present invention therefore is to provide a technique to be able to obtain a desired video signal that in an image input device to which a color separation filter using a single-layer inorganic material is loaded.

In order to achieve the aforementioned object, it has a feature in the present invention that an image pickup signal obtained from a solid-state image pickup element equipped with a color separation filter film made of a single-layer inorganic material, is signal-processed by a method adapted to the color of the signal and the type of the outputted signal.

That is, an image input device of the present invention comprises a solid-state image pickup element for picking up an image of a subject, and
a signal processor for signal-processing an image pickup signal outputted from the solid-state image pickup element, wherein:
the solid-state image pickup element comprises a filter film made of a single-layer inorganic material which exhibits a maximum value for a specific wavelength on transmission spectra of incident light in accordance with a film thickness thereof, and a photoelectrical conversion part for generating a signal charge in accordance with light quantity of the incident light transmitted through the filter film, wherein a number of at least two kinds of the filter films with different film thickness is provided, and a large number of the filter films are arranged in parallel based on a prescribed arrangement; and
the signal processor generates at least one of the signals that correspond to a luminance signal, a color signal, a color difference signal, and light quantity of incident light by applying color conversion processing on the image pickup signal in accordance with the prescribed arrangement.

According to this, it becomes possible to obtain desired video signals from the image pickup signals of the solid-state image pickup element even if the filter film for color separation is made of a single-layer inorganic material.

It should be noted that it is preferable to satisfy the relation of y≦x, assuming that there are x-kinds (x: a natural number of 2 or larger) of the filter films in terms of the light transmission characteristic, and y-kinds (y: natural number) of signals outputted from the signal processor. By doing like this, it becomes possible to achieve the delicate adjustment of the video information contained in the output signals in the signal processor.

In addition, it is desirable that a number of three kinds of filter films with a different film thickness from each other, is provided and the filter films are arranged in parallel based on an array unit of two lines in two columns, wherein the filter films having a first film thickness and a third film thickness are arranged in order in a first column of the array unit; and the filter films having a second film thickness and the first film thickness are arranged in order in a second column of the array unit.

It is assumed that there are three kinds of light transmission characteristics, by doing like this, the structure of the signal processor can have a high affinity for those that correspond to the output of a conventional Bayer-array image pickup element. Therefore, the number of designing steps can be reduced greatly.

It is preferable that the thickness of the first film, the second film, and the third film are set thicker in order of the second film thickness, the first film thickness, and the third film thickness. By doing this, it becomes a Bayer array of GBRG by making the first film thickness correspond to G (green), the second film thickness to R (red), and the third film thickness to B (blue), respectively.

It is desirable that a number of four kinds of filter films with a different film thickness from each other is provided, and the filter films are arranged in parallel based on an array unit of two lines in two columns, wherein

the filter films having a first film thickness and a second film thickness are arranged in order in a first column of the array unit; and the filter films having a third film thickness and a fourth film thickness are arranged in order in a second column of the array unit.

It is assumed that there are four kinds of light transmission characteristics, by doing this, the structure of the signal processor can have a high affinity for those that correspond to the output of a conventional checkered-type complementary color array image pickup element. Therefore, the number of designing steps can be reduced greatly.

Further, it is desirable that a number of four kinds of filter films with a different film thickness from each other is provided, and the filter films are arranged in parallel based on an array unit of four lines in two columns, wherein
the filter films having a first film thickness, a second film thickness, the first film thickness, and a fourth film thickness are arranged in order on a first column of the array unit; and the filter films having a third film thickness, the fourth film thickness, the third film thickness, and the second film thickness are arranged in order in a second column of the array unit.

By doing this, as the structure of the signal processor can have a high affinity for those that correspond to the output of a conventional movie-type complementary color array image pickup element, the number of designing steps can be reduced greatly.

Furthermore, it is desirable that a number of four kinds of filter films with a different film thickness from each other is provided, and the filter films are arranged in parallel based on an array unit of four lines in two columns, wherein
the filter films having a first film thickness, a second film thickness, a first film thickness, and a fourth film thickness are arranged in order in a first column of the array unit; and the filter films having the third film thickness, the fourth film thickness, the film third thickness, and the second film thickness are arranged in order in a second column of the array unit.

By doing this, as the structure of the signal processor can have a high affinity for those that correspond to the output of a conventional whole-line-inversion movie-type complementary color array image pickup element, the number of designing steps can be reduced greatly.

It is desirable that the image pickup signal include 1st to n-th image pickup signal (n is a natural number of 2 or more), which are generated through performing photoelectrical conversion processing on incident light transmitting through the 1st to n-th filter films having a different film thickness from each other by the photoelectrical conversion part; and
the signal processor executes color conversion processing expressed by adding or subtracting a constant with respect to a linear combination expression of the 1st to n-th image pickup signals.

By doing this, it becomes possible in the signal processor to achieve the detailed adjustment of the video information contained in the output signals.

It is desirable for the signal processor to generate the luminance signal by executing the color conversion processing that multiplies a first constant and adds or subtracts a second constant with respect to one kind among the 1st to n-th image pickup signals. By doing this, the redundant circuits can be cut and the scale of the circuit can be reduced.

It is desirable that the signal-processing in the signal processor execute the color conversion processing in which, in a shape of gamma correction function, second differential value of the gamma correction function is expressed as 0 or more in an area where an input is smaller than a prescribed threshold value, and second differential value of the gamma correction function is expressed as 0 or less in an area where an input is larger than the prescribed threshold value. That is, the shape is convex downwards when the input is smaller than the threshold value, while the shape is convex upwards when the input is larger than the prescribed threshold value. By doing this, it is possible to obtain the high-quality signals with suppressed sense of noise in the luminance part.

It is desirable for the signal processor to execute the color conversion processing in which, in a shape of gamma correction function, second differential value of the gamma correction function is expressed as 0 or more. That is, the shape is convex downwards entirely. By doing this, it is possible to obtain the high-quality signals with more suppressed sense of noise.

It is desirable for the signal processor to execute the color conversion processing in which shape of gamma correction function is expressed with a linear function and a combination of linear functions, i.e. multiple-line approximation is carried out by linear functions. By doing this, the processing can be simplified and the scale of the circuit can be reduced.

It is preferable for the color conversion processing to include the processing for eliminating the noise component.

It is preferable for the color conversion processing to include processing for transmitting through only a signal of less than a prescribed band of a color difference signal in a frequency component. That is, it is desirable for the signal processor to comprise an LFP (Low Pass Filter) for transmitting through only the color difference signal of less than a prescribed frequency band. According to this, it is possible to obtain the high-quality signals with the suppressed sense of noise in the color difference signals.

Further, it is desirable for the prescribed band to be lower than the band of the luminance signal. That is, it is desirable for the signal processor to be in the structure where the frequency band of the luminance signal is lower than that of the color difference signal. By doing this, it becomes possible to obtain the high-quality signals with the suppressed sense of noise in the color difference signals, while sufficiently keeping the degree of the resolution in the luminance signal.

It is desirable for the solid-state image pickup element to comprise an IR (Infrared Rays) cut filter for eliminating near infrared rays on its incident light path. According to this, the video signals in the near infrared area can be utilized, so that the amount of information of the image pickup signals can be expanded. However, it is also preferable even without providing the IR cur filter.

The present invention can be developed as a solid-state image pickup element in the following manner. That is, the solid-state image pickup element of the present invention comprises a filter film which exhibits different maximum values from each other with respect to at least three wavelengths on transmission spectra of incident light, and
a photoelectrical conversion part for generating a signal charge in accordance with light quantity of the incident light transmitted through the filter film, wherein
the wavelengths are included in a wave range of 650 nm-750 nm, a wave range of 525 nm-625 nm, and a wave range of 380 nm-480 nm.

It is desirable that the wavelengths are 700 nm, 575 nm, and 435 nm, respectively.

It is desirable for the film filter to be made of a single-layer inorganic material that exhibits a maximum value for a specific wavelength of transmission spectra of incident light in accordance with its film thickness.

It is desirable for the filter film to comprise a filter film having a film thickness of 65-100 nm, a filter film having a film thickness of 50-70 nm, and a filter film having a film thickness of 30-50 nm, and the filter films are arranged in parallel based on a prescribed arrangement, wherein
thickness of the filter films is set according to correlation between refractive index thereof and wavelengths that exhibit the maximum values.

It is desirable for the three kinds of filter films to be arranged in parallel based on an array unit of two lines in two columns, wherein:
the filter film having the maximum value in a range of 650 nm-750 nm and the filter film having the maximum value in a range of 525 nm-625 nm are arranged in order in a first column of the array unit; and
the filter film having the maximum value in a range of 525 nm-625 nm and the filter film having the maximum value in a range of 380 nm-480 nm are arranged in order in a second column of the array unit. This corresponds to the output of a Bayer-array type image pickup element.

Further, there is another embodiment of the solid-state image pickup element of the present invention, which comprises a filter film with a transmission characteristic for transmitting light of at least three wavelengths on transmission spectra of incident light, and
a photoelectrical conversion part for generating a signal charge in accordance with light quantity of the incident light transmitted through the filter film, wherein
the wavelengths include that of 650 nm or more, 525 nm or more, and 380 nm or more.

It is desirable for the filter film to exhibit the maximum values in the wave ranges of 650 nm-750 nm, 525 nm-625 nm, and 380 nm-480 nm.

Alternatively, it is desirable for the wavelengths to include that of less than 700 nm, less than 575 nm, and less than 435 nm.

It is desirable for the filter film to be made of a single-layer inorganic material with different film thicknesses.

Further, it is preferable for the filter film to comprise a filter film having a film thickness of 65-100 nm, a filter film having a film thickness of 50-70 nm, and a filter film having a film thickness of 30-50 nm, and the filter films are arranged in parallel based on a prescribed arrangement, wherein
film thicknesses of the filter films are set according to correlation between refractive index thereof and wavelengths that exhibit the maximum values on transmission spectra of the filter film.

It is desirable for the filter films to be arranged in parallel based on an array unit of two lines in two columns, wherein:
the filter film having the maximum value on the transmission spectra of the filter film in a range of 650 nm-750 nm and the filter film having a cutoff specific wavelength within a range of 525 nm-625 nm are arranged in order in a first column of the array unit; and
the filter film having the cutoff specific wavelength in a range of 525 nm-625 nm and the filter film having the maximum value in a range of 380 nm-480 nm are arranged in order in a second column of the array unit. This corresponds to the Bayer array.

Furthermore, it is desirable to comprise one of the above-described solid-state image pickup elements and a signal processor for signal-processing an image pickup signal that is outputted from the solid-state image pickup element, wherein
the signal processor generates at least one signal out of the signals that correspond to a luminance signal, a color signal, a color difference signal, and light quantity of incident light by applying color conversion processing on the image pickup signal according to the array unit.

According to this, the signal processor performs processing on the image pickup signals by the methods that are adapted to the colors and the types of the output signals. Thus, it is possible to obtain the desired video signals form the image pickup signals of the solid-state image pickup element even if the filter film for color separation is made of a single-layer inorganic material.

According to the present invention, the desired video signals can be obtained from the image pickup signals of the solid-state image pickup element even if the filter film for color separation is made of a single-layer inorganic material because the signal processor performs processing on the image pickup signals by the methods that are adapted to the colors and the types of the output signals.

The image input device and the solid-state image pickup element of the present invention are effective as the devices capable of obtaining the desired signals in an image pickup device that comprises a color filter made of a single-layer inorganic material whose light transmission characteristic is largely different from that of the conventional primary- and complementary-color filters.

### BRIEF DESCRIPTION OF THE DRAWINGS

Other objects of the present invention will become clear from the following description of the preferred embodiments and the appended claims. Those skilled in the art will appreciate that there are many other advantages of the present invention not mentioned in the specification by embodying the present invention.

FIG. 1 is a block diagram for showing the functional structure of an electronic still camera according to a first embodiment of the present invention;

FIG. 2 is a block diagram for showing a schematic structure of an image sensor according to the first embodiment of the present invention;

FIG. 3 is a cross sectional view for showing a part of the structure of the image sensor according to the first embodiment of the present invention;

FIG. 4 is a block diagram for showing the functional structure of a digital signal processing circuit according to the first embodiment of the present invention;

FIG. 5 is a block diagram for showing the functional structure of an YC processing circuit according to the first embodiment of the present invention;

FIG. 6 is a block diagram for showing the functional structure of a color matrix circuit according to the first embodiment of the present invention;

FIG. 7A is a graph for showing the input/output characteristics of a gamma correction circuit according to the first embodiment of the present invention;

FIG. 7B is a graph for showing the gamma characteristic of CRT of a display device according to the first embodiment of the present invention;

FIG. 8A is a graph for showing the transmission characteristics of a color filter according to the first embodiment of the present invention (film thickness of amorphous silicon: 30 nm, 40 nm, 55 nm, 70 nm);

FIG. 8B is a graph for showing the responses of the video signal outputs (R, G, B);

FIG. 9 is a graph for showing the input/output characteristics of a gamma correction circuit according to a second embodiment of the present invention;

FIG. 10 is a graph for showing a modification example of the gamma correction circuit according to the second embodiment of the present invention;

FIG. 11A is a graph for showing only characteristic 82 of a color filter according to a third embodiment of the present invention;

FIG. 11B is a graph for showing the characteristic of an IR cut filter, and the characteristic combining both the characteristic 82 of the color filter and that of the IR cut filter;

FIG. 12A is a view for showing the color filter arrangement according to a third embodiment of the present invention;

FIG. 12B is a view for showing the color filter arrangement according to a fifth embodiment of the present invention;

FIG. 12C is a view for showing a first modification example of the color filter arrangement according to the fifth embodiment of the present invention;

FIG. 12D is a view for showing a second modification example of the color filter arrangement according to the fifth embodiment of the present invention;

FIG. 13 is a block diagram for showing the functional structure of an YC processing circuit according to a fourth embodiment of the present invention;

FIG. 14 is a block diagram for showing the functional structure of a color matrix circuit according to the fourth embodiment of the present invention;

FIG. 15 is a block diagram for showing the functional structure of an YC processing circuit according to the fifth embodiment of the present invention;

FIG. 16 is a block diagram for showing the functional structure of a color matrix circuit according to the fifth embodiment of the present invention;

FIG. 17 is a block diagram for showing the functional structure of an YC processing circuit according to a sixth embodiment of the present invention;

FIG. 18 is a block diagram for showing the functional structure of a color difference signal NR circuit according to the sixth embodiment of the present invention;

FIG. 19 is a block diagram for showing the functional structure of a luminance color difference RGB converter circuit according to the sixth embodiment of the present invention;

FIG. 20 is a block diagram for showing the functional structure of a color matrix circuit according to a seventh embodiment of the present invention;

FIG. 21 is a block diagram for showing the functional structure of an electronic still camera according to an eighth embodiment of the present invention;

FIG. 22 is a graph for showing the transmission characteristics of color filters according to the eighth embodiment of the present invention (the one having a peak at the wavelength that can be visible to human beings, the one having a peak at near infrared wavelength);

FIG. 23 is a block diagram for showing the functional structure of a color matrix circuit according to the eighth embodiment of the present invention;

FIG. 24 is a graph (simplified for explanation) for showing the transmission characteristic of the filter and the energy distribution when the filter colors according to a ninth embodiment of the present invention are made of R/Ye/W components;

FIG. 25A is an illustration for showing a typical example (aligned in the order of the longer wavelength from the top left towards the lateral direction) of the filter arrangement when the filter colors according to a ninth embodiment of the present invention are made of R/Ye/W components; and

FIG. 25B is an illustration for showing a modification example (other than the above-described example) of the filter arrangement when the filter colors according to the ninth embodiment of the present invention are made of R/Ye/W components.

### DETAILED DESCRIPTION OF THE DRAWINGS

Hereinafter, embodiments of an image input device according to the present invention will be described by taking an electronic still camera as example, referring to the accompanying drawings.

### First Embodiment

Description will be given to the electronic still camera according to a first embodiment of the present invention.

(1) Structure of Electronic Still Camera

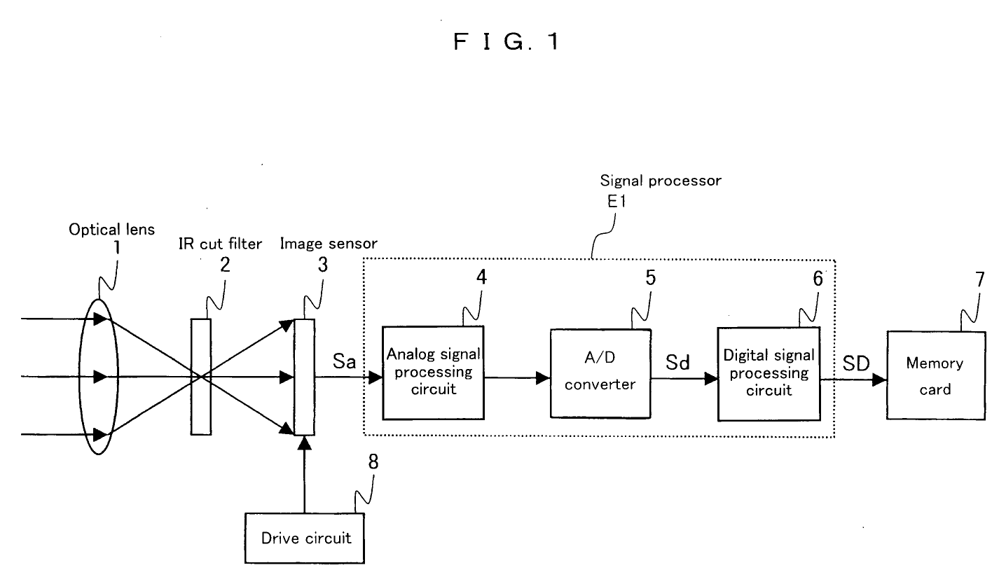

First, the structure of the electronic still camera according to this embodiment will be described. FIG. 1 is a block diagram for showing the functional structure of the electronic still camera of the embodiment. This electronic still camera comprises an optical lens 1, an IR cut filter 2, an image sensor (solid-state image pickup element) 3, an analog signal processing circuit 4, an A/D (Analog to Digital) converter 5, a digital signal processing circuit 6, a memory card 7, and a drive circuit 8. The analog signal processing circuit 4, the A/D converter 5, and the digital signal processing circuit 6 constitutes a signal processor E1.

The optical lens 1 forms an image of the incident light from a subjecton the image sensor 3. The IR cut filter 2 eliminates the long wavelength component of the light that enters on the image sensor 3. The image sensor 3 is constituted with, for example, a single-plate CCD (Charge Coupled Device) image sensor which comprises color filters for filtering the incident light provided at each of photoelectric conversion elements that are arranged two-dimensionally. The image sensor 3 reads out the electric charge in accordance with a drive signal from the drive circuit 8, and outputs an analog image pickup signal Sa.

The analog signal processing circuit 4 performs processing such as correlational double sampling and signal amplification on the analog image pickup signal Sa outputted from the image sensor 3. The A/D converter 5 converts the output signal of the analog signal processing circuit 4 into a digital image pickup signal Sd. The digital signal processing circuit 6 generates a desired digital video signal SD from the digital image pickup signal Sd. The video signal SD is recorded in the memory card 7.

(2) Structure of Image Sensor

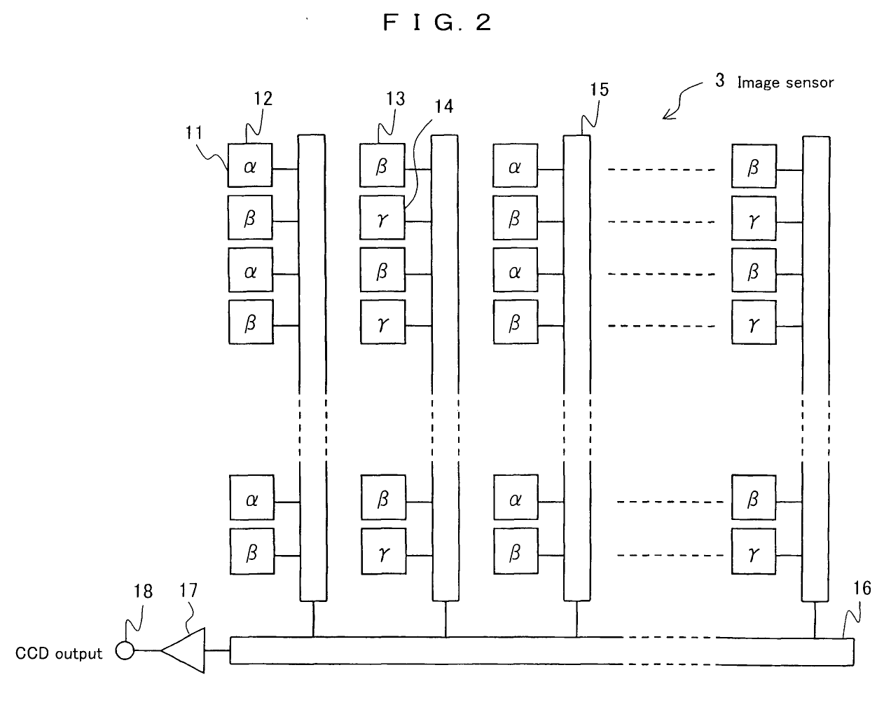

FIG. 2 is a block diagram for showing the schematic structure of the image sensor 3. The image sensor 3 comprise photoelectric conversion elements 11, color filters 12-14, vertical transfer CCD 15, horizontal transfer CCD 16, an amplifier circuit 17, and an output terminal 18. The color filters are made of a single-layer inorganic material.

The photoelectric conversion elements 11 are arranged two-dimensionally and, on each of the photoelectrical conversion elements 11, one of the color filters, i.e. the color filter 12 of the first color component α, the color filter 12 of the second color component β, and the color filter 14 of the third color component γ is arranged in Bayer form. The color component corresponding to the position of R in the array unit of the Bayer array is the first color component α, the color component corresponding to the poison of G is the second color component β, and the color component corresponding to the poison of B is the third color component γ, respectively. Among the light that enters on the color filters, only the components of specific colors reach the photoelectric conversion elements 11 and are converted to the charge signals. The vertical transfer CCD 15 transfers the charge signal of each photoelectrical conversion element 11 to the horizontal transfer CCD 16 in accordance with the drive pulse from the drive circuit 8. The horizontal transfer CCD 16 also transfers the charge signals from the vertical transfer CCD 15 to the amplifier circuit 17 in accordance with the drive pulse from the drive circuit 8. The amplifier circuit 17 converts the charge signals to the voltage signals, which are then outputted from the output terminal 18.

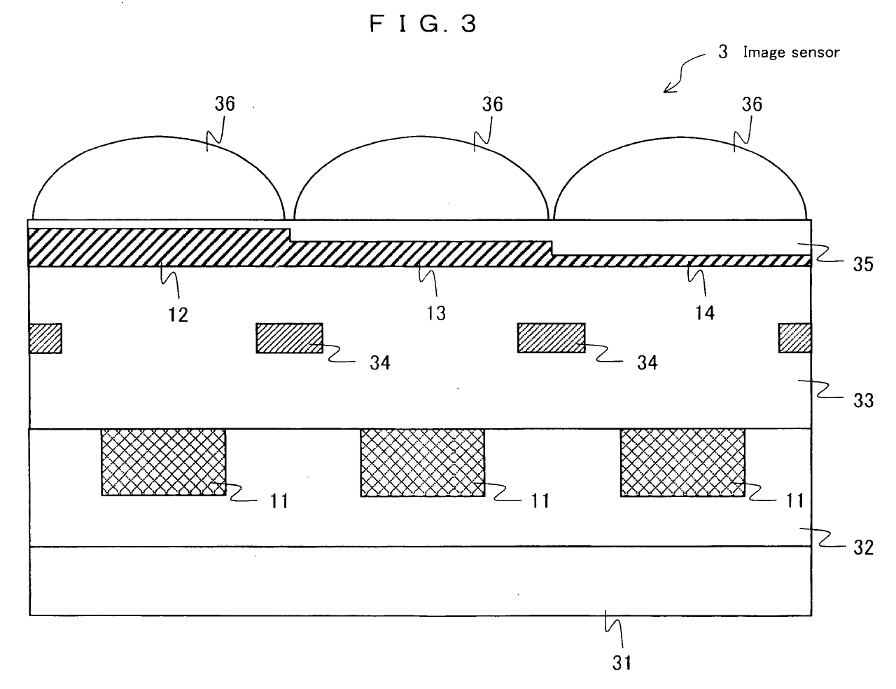

FIG. 3 is a cross sectional view for showing a part of the structure of the image sensor 3. The image sensor 3 comprises an N-type semiconductor layer 31, a P-type semiconductor layer 32, an insulating film 33, the photoelectrical conversion elements 11, a shielding film 34, the color filters 12-14, a planarized film 35 made of silicon dioxide, and a condenser lens (micro lens) 36.

The P-type semiconductor layer 32 is formed on the N-type semiconductor layer 31. The photoelectrical conversion elements 11 are formed by ionic implantation of N-type impurity to the P-type semiconductor layer 32. The light-transmitting insulating film 33 is formed on the P-type semiconductor layer 32 and the photoelectrical conversion elements 11. The shielding film 34 is provided on the insulating film 33 so that only the light transmitted through a specific color filter enters on the photoelectrical conversion elements 11. The color filters 12-14 are formed on the insulating film 33. The planarized film 35 made of silicon dioxide is provided on the color filters 12-14 for planarizing the elements. The condenser lens 36 for condensing the incident light on the photoelectrical conversion elements 11 by corresponding to the positions of the color filters, is provided on the planarized film 35.

The color filters 12-14 are filter films made of a single-layer amorphous silicon (inorganic material), and the film thickness of each light-receiving cell is determined so as to transmit the light of a prescribed wavelength range. Saying further in detail, the film thicknesses are determined after the wavelengths exhibiting the maximum transmission amount (referred to as the maximum wavelength hereinafter) are determined. Specifically, assuming that the maximum wavelength in the area of the first color component α is 650 nm, that in the second color component β is 530 nm, and that in the third color component γ is 470 nm, the refractive indexes at the maximum wavelengths of 650 nm, 530 nm, and 470 nm are 4.5, 4.75, and 5.0, respectively. There is a following relationship between the maximum wavelength λ, the refractive index n, and the film thickness d of the filter film.
N d=λ/2

Thus, when the film thicknesses exhibiting the maximum wavelengths in the wavelength areas of the first color component α, the second color component β, and the third color component γ are defined as “da”, “db”, and “dc”, respectively, they becomes as below.
da=70 nm
db=55 nm
dc=40 nm

The thicker the film thickness becomes, the more the maximum wavelength shifts to the long wavelength side. The first film thickness (40 nm) and the second film thickness (55 nm) is obtained wherein the second wavelength (560 nm) that is on the longer wave side than the first wavelength (470 nm) is the maximum wavelengths, and the first film thickness is thinner than the second film thickness. The wavelengths of the visible light is 300 nm-800 nm, so that the product (n·d) of the film thickness of the filter and the refractive index gets on to be selected from the range of 150 nm-400 nm, both inclusive.

Here, amorphous silicon that is an absorbent material is used for the filter film. The reason will be described hereinafter. The absorbent material is defined as a material in which the wavelength exhibiting attenuation coefficient of 0.1 or more is in the band of 400 nm-700 nm. Examples of such absorbent material are polysilicon, single crystal silicon, titanium oxide, tantalum oxide, niobium oxide. These are preferable examples of the inorganic materials for the present invention.

Generally, in a medium formed with a uniform film thickness, when reflection is generated between the medium and an external medium, the wavelength at which the intensities are increased mutually or are weakened mutually according to the film thickness of the medium is determined. Interference is caused due to such reflection characteristic. Amorphous silicon has a large refractive index so that the reflection is also large. Furthermore, amorphous silicon has a characteristic of absorbing the light in a specific wavelength region because the attenuation coefficient thereof is large.

With the help of the above-described characteristics of the amorphous silicon, the filter films in all of the pixel cells are formed with a single amorphous silicon material that is an inorganic material. Amorphous silicon has a characteristic of making the light of different wave range pass in accordance with its film thickness. Thus, by providing the different film thickness for each light-receiving cell, the film can function as the color filters.

For the filter film formed with amorphous silicon in this manner, the wave range of the transmission light is not determined by using different pigments or dye for each color, but by setting the different film thicknesses for each color. Therefore, control of materials such as pigments or dyes becomes unnecessary in the manufacturing steps. Thus, the cost can be reduced.

Further, the filter film is produced through a semiconductor process so that a manufacturing process for the color filters, with handling acryl resin, becomes unnecessary. As a result, manufacture equipment thereof can be diverted to some other purposes and the manufacturing steps can be simplified.

Furthermore, as the thickness of the filter film is extremely thin like 70 nm at the most, it is also effective as a means for preventing mixture of colors that may be caused when the light transmitted through the filter film of the adjacent light-receiving cell enters thereon. As described above, the maximum wavelength is defined as n·d=λ/2, so that an excellent color separation characteristic can be obtained by setting the film thickness such that the maximum wavelength is disposed in the visible light area.

Moreover, the filter film made of amorphous silicon can be formed at a low temperature. Thus, it can be formed after forming the shielding film made of aluminum or the like having a low melting point. Further, the stress of this filter film can be made smaller so as to be able to minimize damages to the photoelectric conversion part. Furthermore, by changing the film thickness under a condition where the product of the thickness of the filter film and the refractive index are set as 150 nm or more and 400 nm or less, it is possible to control the wavelengths interfering in the light visible area. As a result, separation of the colors can be achieved.

However, compared to the color filter using an organic material, the color filter using an inorganic material such as typically amorphous silicon, has the light transmission characteristic that is largely different. Thus, it is not possible to obtain desired signal by processing the video signals that are generated after execution of the optical processing with the color filter using the inorganic material, with a conventional signal processing method. This issue is settled with the digital signal processing circuit in the present invention.

(3) Digital Signal Processing Circuit

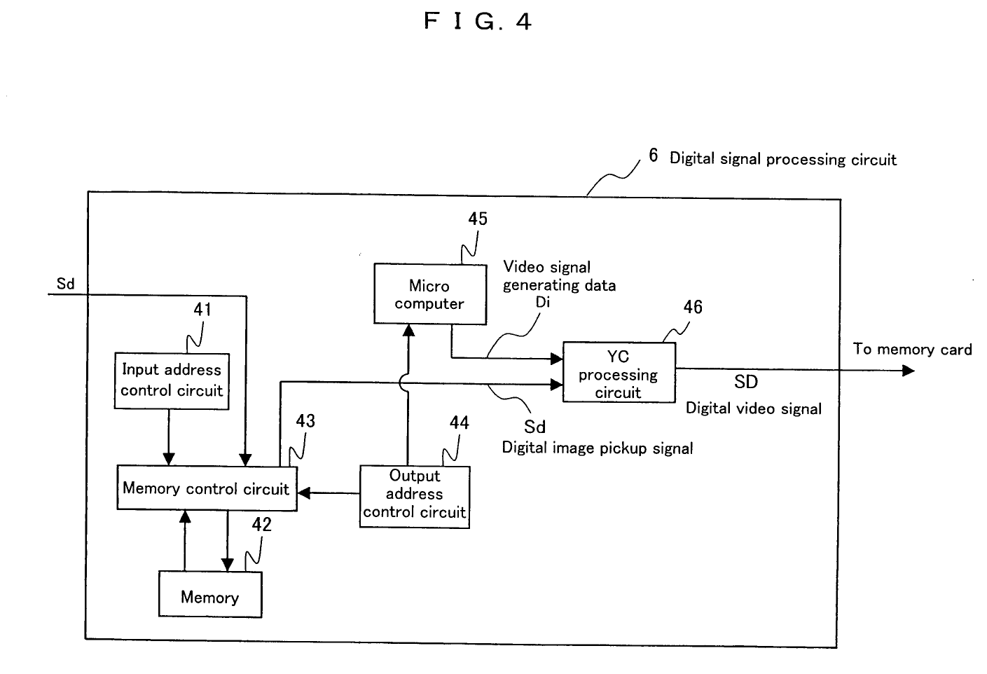

FIG. 4 is a block diagram for showing the functional structure of the digital signal processing circuit 6. The digital signal processing circuit 6 comprises an input address control circuit 41, a memory 42, a memory control circuit 43, an output address control circuit 44, a microcomputer 45, and an YC processing circuit 46.

The input address control circuit 41 controls the address of the digital image pickup signal Sd. The memory 42 records the digital image pickup signal Sd. The output address control circuit 44 controls the address for reading out the digital image pickup signal Sd recorded in the memory 42. The output address control circuit 44 controls video signal generating data Di outputted from the microcomputer 45. The video signal generating data Di is used for correcting the digital image pickup signal Sd. The memory control circuit 43 generates the control signal for controlling the reading/writing of the data and outputs it to the memory 42. The memory control circuit 43 generates the above-described control signal in accordance with the control signals of the input address control circuit 41 and the output address control circuit 44.

The microcomputer 45 generates the video signal generating data Di and supplies it to the YC processing circuit 46. The YC processing circuit 46 generates digital video signal SD from the digital video signal Sd based on the video signal generating data Di. Further, the YC processing circuit 46 outputs the generated digital video signal SD after applying the signal processing, e.g. gamma correction, to that signal SD.

(4) YC Processing Circuit

FIG. 5 is a block diagram for showing the structure of the YC processing circuit. The YC processing circuit 46 comprises a synchronization processing circuit 51, a color matrix circuit 52, and a gamma correction circuit 53. The synchronization processing circuit 51 performs synchronization of the digital image pickup signal Sd outputted from the memory control circuit 43 by each of the color components, i.e. the first color component α, the second color component β, and the third color component γ. The color matrix circuit 52 carries out an arithmetic operation of the digital image pickup signal Sd synchronized by each color in the synchronization processing circuit 51 and the video signal generating data Di in order to generate the digital video signal SD constituted with the three primary colors of R (red), G (green), and B (blue). The gamma correction circuit 53 is a circuit for correcting the gamma characteristic of CRT (Cathode Ray tube) that is a device for display, which converts the digital video signal SD to have an inverse characteristic of the gamma characteristic.

(5) Color Matrix Circuit

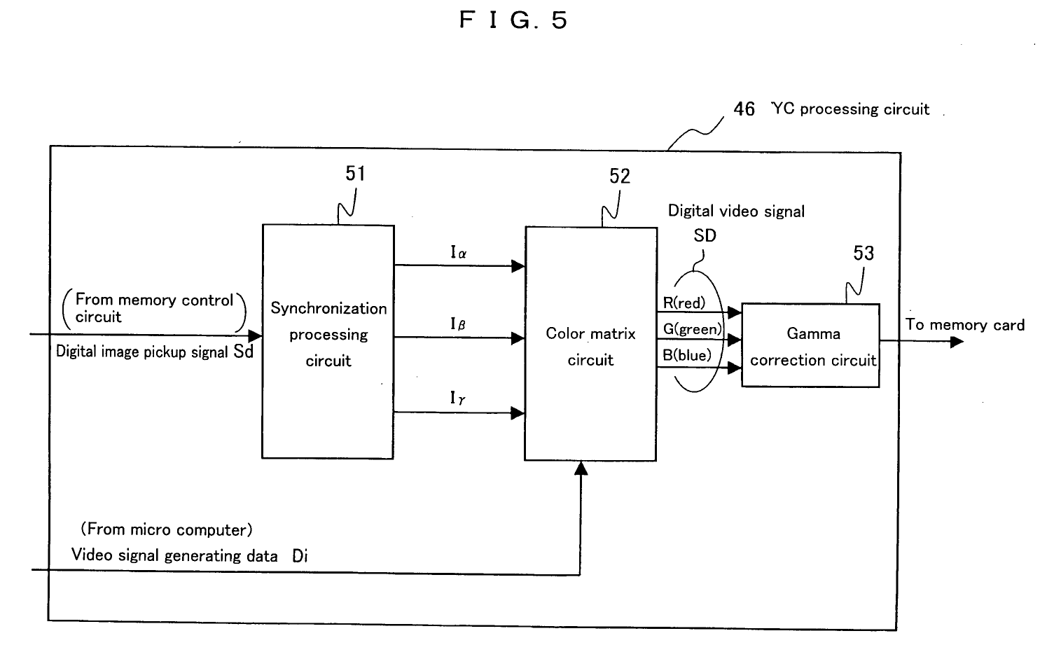

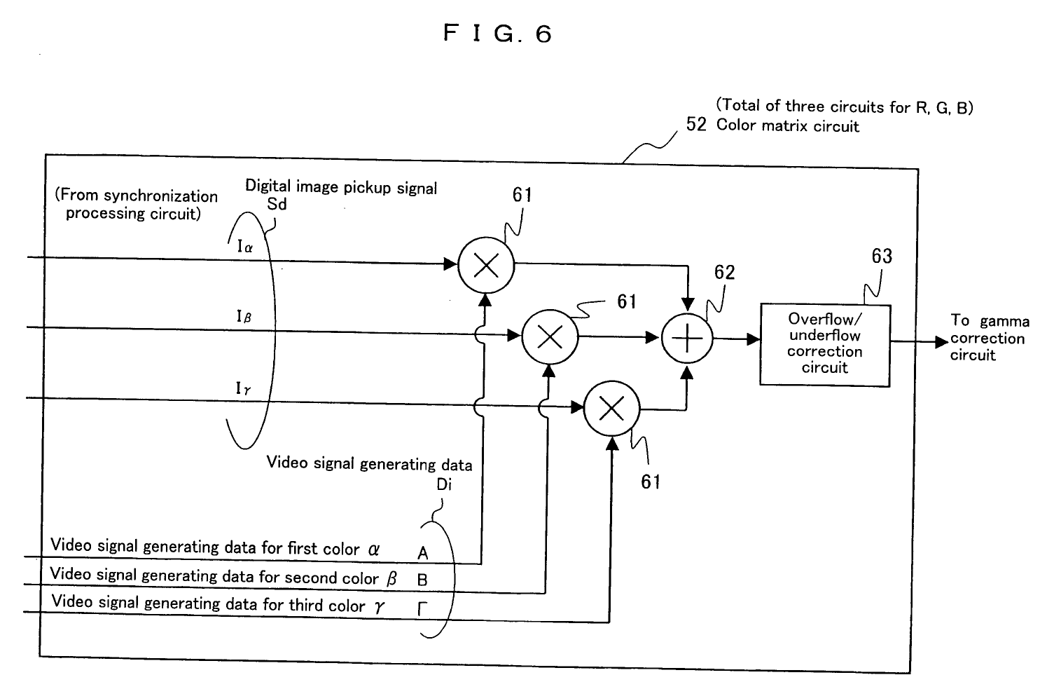

FIG. 6 is a block diagram for showing the structure of the color matrix circuit 52. The color matrix circuit 52 is constructed with three circuits shown in FIG. 6 for generating R (red), G (green) and B (blue). Each of the circuits comprises a multiplier 61, an adder 62, and an overflow/underflow correction circuit 63.

Flow of the processing will be described referring to one of the three circuits mentioned above as an example. First, the multiplier 61 multiplies each of the color signals Iα, Iβ, Iγ of respective color components α, β, γ of the digital image pickup signal Sd that is synchronized by the synchronization processing circuit 51, by video signal generating data A, B, Γ. The video signal generating data A is the data for the first color component, the video signal generating data B is the data for the second color component, and the video signal generating data Γ is the data for the third color component.

The adder 62 adds the three multiplication results of the multiplier 61. The adding result by the adder 62 can be expressed by Expression 1.
(Output of Adder 62)=(A*Iα)+(B*Iβ)+(Γr*Iγ) [Expression 1]

By the way, the adding result of the adder 62 obtained from Expression 1 that is equivalent to the circuit shown in FIG. 6 corresponds to R (red), G (green), and B (blue) outputted from the color matrix circuit 52. Thus, Expression 2 is obtained from the relationship between Expression 1 and the output signals of the color matrix circuit 52.
(R(red))=(AR*Iα)+(BR*Iβ)+(ΓR*Iγ)
(G(green))=(AG*Iα)+(BG*Iβ)+(ΓG*Iγ)
(B(blue))=(AB*Iα)+(BB*Iβ)+(ΓB*Iγ)

AR, AG, AB are the coefficients to be multiplied to the color signal Iα of the digital image pickup signal Sd for outputting R (red), G (green) and B (blue), respectively. BR, BG, BB are the coefficients to be multiplied to the color signal Iβ of the digital image pickup signal Sd for outputting R (red), G (green) and B (blue), respectively. ΓR, ΓG, ΓB are the coefficients to be multiplied to the color signal Iγ of the digital image pickup signal Sd for outputting R (red), G (green) and B (blue), respectively.

Then, the overflow/underflow correction circuit 63 performs clipping processing when the adding result of the adder 62 obtained from Expression 1 exceeds a prescribed bit range, so as to output the adding result by correcting it to be within the prescribed bit range.

(6) Gamma Correction Circuit

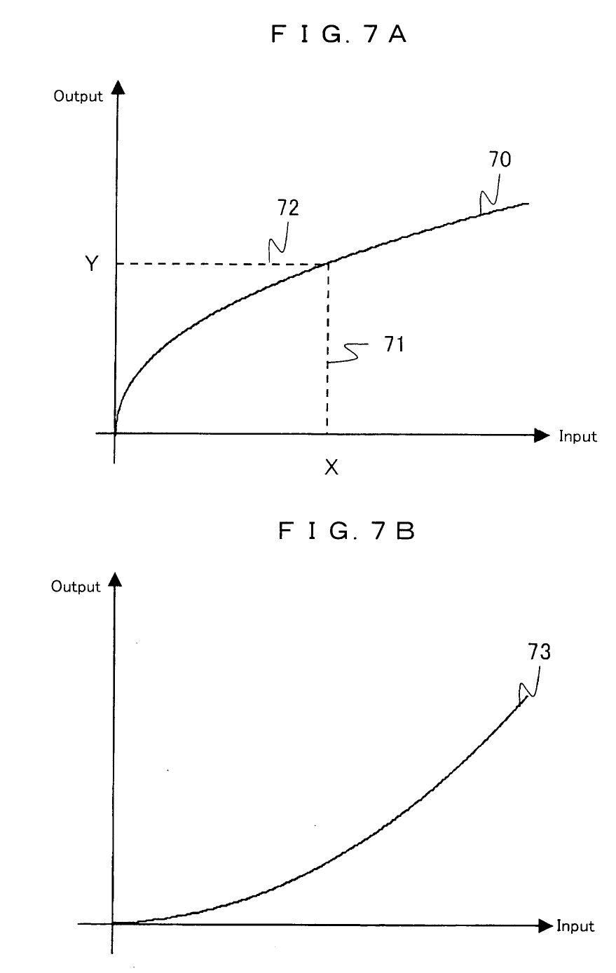

FIG. 7A is a graph for showing the input/output relationship of the gamma correction circuit 53, and FIG. 7B is a graph for showing the input/output relationship of the gamma characteristic of the CRT as a display device. In these graphs, the horizontal axis corresponds to the input and the vertical axis to the output, respectively. When the level X in the output 71 of FIG. 7A is inputted to the gamma correction circuit 53, the gamma correction circuit 53 outputs the level Y as the output 72. It is the same for the input/output relationship of the gamma characteristic of the CRT. Generally, it is preferable for the characteristic 70 and the characteristic 73 to be in a relation of inverse functions.

(7) Video Signal Generating Data

The microcomputer 45 outputs the video signal generating data Di that corresponds to each color component of the synchronized digital image pickup signal Sd. In this embodiment, the number of color components of the synchronized video signal is “3” (the first color component α, the second color component β, and the third color component γ) and the number of signals outputted as the video signals is “3” (R (red), G (green), and B (blue)). Thus, the microcomputer 45 outputs nine video signal generating data Di (AR, AG, AB, BR, BG, BB, ΓR, ΓG, ΓB).

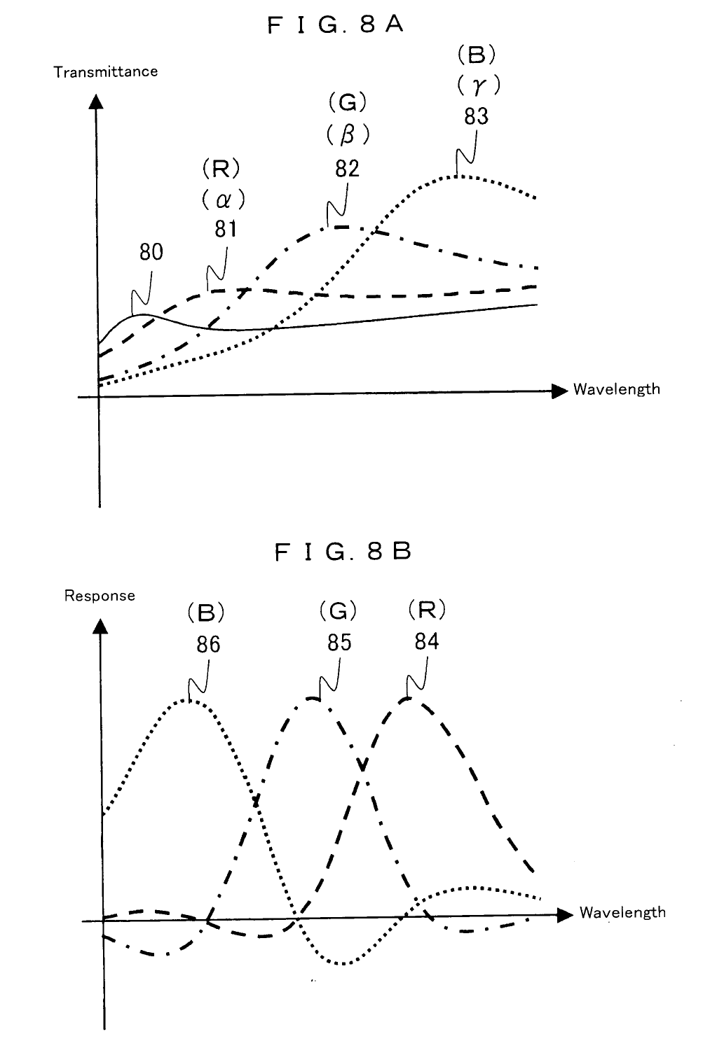

FIG. 8A and FIG. 8B shows the light transmission characteristics and the responses according to the above-described structure. In these graphs, the horizontal axis (wavelength) corresponds to the wavelengths of 400 nm-700 nm to that human beings have a visible sensitivity. FIG. 8A shows the light transmission characteristic of the color filter made of a single-layer inorganic material according to this embodiment. Reference numerals 81, 82, and 83 correspond to the first color component α, the second color component β, and the third color component γ of Expression 2, respectively. FIG. 8B shows the responses of R (red), G (green), and B (blue) outputted from the color matrix circuit 52, and reference numerals 84, 85, and 86 correspond thereto, respectively.

The characteristics shown in FIG. 8B are almost the same as the ideal imaging characteristics of NTSC (National Television Standards Committee), which are preferable in terms of color regeneration. The signal processor E1 is constituted with the analog signal processing circuit 4, the A/D converter 5, and the digital signal processing circuit 6, wherein the A/D converter 5 converts the analog image pickup signal Sa outputted from the image sensor 3 into the digital image pickup signal Sd.

The YC processing circuit in the digital signal processing circuit 6 converts the digital image pickup signal Sd to the digital image pickup signal SD based on the video signal generating data Di. That is, the YC-processing circuit 46 is constituted with the synchronization processing circuit 51, the color matrix circuit 52, and the gamma correction circuit 53. The color matrix circuit 52 converts the digital image pickup signal Sd that is constituted with the image pickup signal Iα of the synchronized first color component α, the image pickup signal Iβ of the synchronized second color component β, and the image pickup signal Iγ of the synchronized third color component γ, into the digital video signal SD of the R, G, B color signals based on the video signal generating data Di. Like this, the image pickup signals are processed with the method that is adapted to the color component thereof and the type of the signal to be outputted. Thus, even if the color filters 12-14 for color separation are formed with a single-layer inorganic material, it is possible to obtain the desired digital video signal SD from the analog image pickup signal Sa of the image sensor 3.

(8) Modification Example

In the above, the video signal generating data Di is set so that the characteristic of the video signal outputted from the color matrix circuit 52 becomes close to the ideal imaging characteristic of NTSC. However, it is needless to say that the present invention is not limited to that, and video signal generating data Di may be set in such a manner that the ideal characteristic of the image pickup signal becomes close to other characteristic, e.g. the visual sensitivity characteristic of human beings.

Furthermore, in the above, the color component corresponding to the position of R in the array unit of the Bayer array corresponds to the first color component α, the color component corresponding to the position of G to the second color component β, and the color component corresponding to the position of B to the third color component γ, respectively. However, arrangement of each filter for α, β, γ may be changed under specialization to the characteristic of the subject. For example, in the case of an endoscope or the like in which the red components are dominant, it is preferable to arrange the color filter having the sensitivity on the long wave side at the position corresponding to the position of G in the Bayer array, and to arrange the color filters of other light transmission characteristic at the positions corresponding to the respective positions of R and B in the Bayer array.

### Second Embodiment

Next, description will be given to the electronic still camera according to a second embodiment of the present invention. The electronic still camera of this embodiment comprises almost the same structures as the electronic still camera of the first embodiment. However, they are different in terms of the characteristics of the gamma correction. Hereinafter, the second embodiment will be described by focusing attention to the difference.

(1) Gamma Correction Circuit

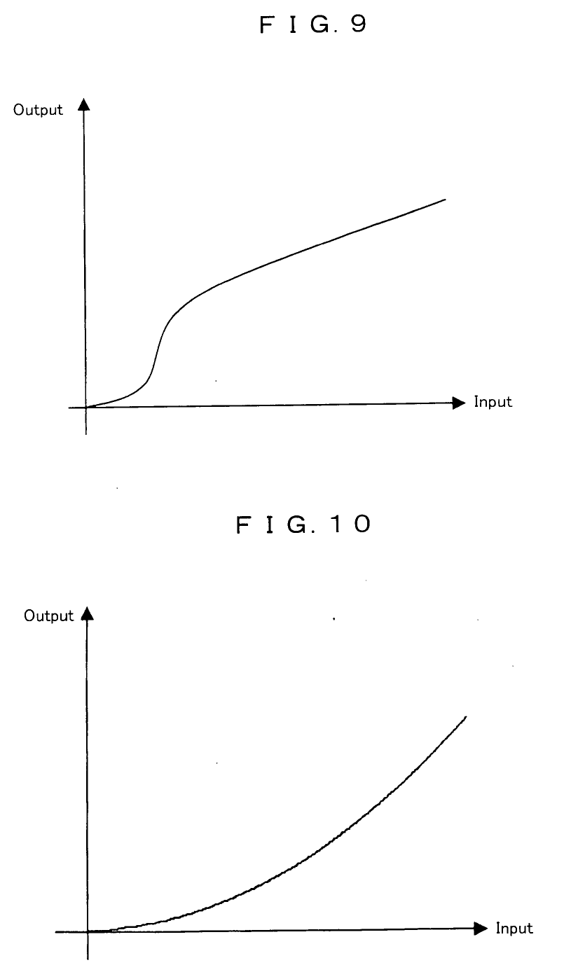

FIG. 9 is a graph for showing the input/output relationship of the gamma correction circuit according to this embodiment. In this embodiment, gain of the low-signal part is smaller than that of the first embodiment (referred to as “S-shape gamma characteristic” hereinafter). Regarding the shape of the gamma correction function, the area where the input is smaller than a prescribed threshold value has a shape in which the second differential value of the gamma correction function is 0 or more, i.e. the shape is convex downwards, whereas the area where the input is larger than the prescribed threshold value has a shape in which the second differential value of the gamma correction function is 0 or less, i.e. the shape is convex upwards.

In general, it is preferable for the gamma correction function to be inverse function with respect to the CRT when the video signal is to be displayed. However, when it is made to be the inverse function of the CRT, the gain of the low-signal part becomes remarkably high, thereby causing a noise problem. Considering the case of having a noise problem such as image recognition or the like, an influence of the noise is reduced in this embodiment with the S-shape gamma characteristic shown in FIG. 9. According to this, it is possible to obtain high-quality signals with the sense of noise being suppressed at the low luminance part.

Further, the characteristic shown in FIG. 10 may be adapted. Regarding the gamma correction function of this case, it becomes a shape in which the second differential value of the gamma correction function is 0 or more, i.e. the shape that is convex downwards entirely. By doing this, it is possible to obtain the high-quality signals in which the sense of noise is more suppressed.

(2) Modification Example

In the above, the gamma correction characteristic is set to be a curve. However, it is needless to say that the present invention is not limited to that but may be approximated by multiple straight lines or may have a straight line and a curve together. With the approximated multiple linear functions, the processing can be simplified and the scale of the circuit can be reduced.

### Third Embodiment

Next, description will be made with respect to the electronic still camera according to a third embodiment of the present invention. The electronic still camera of this embodiment comprises almost the same structures as the electronic still camera of the first embodiment. However, they are different in terms of the setting of the video signal generating data Di. Hereinafter, the third embodiment will be described by focusing attention to the difference.

(1) Method for Setting Video Signal Generating Data Di

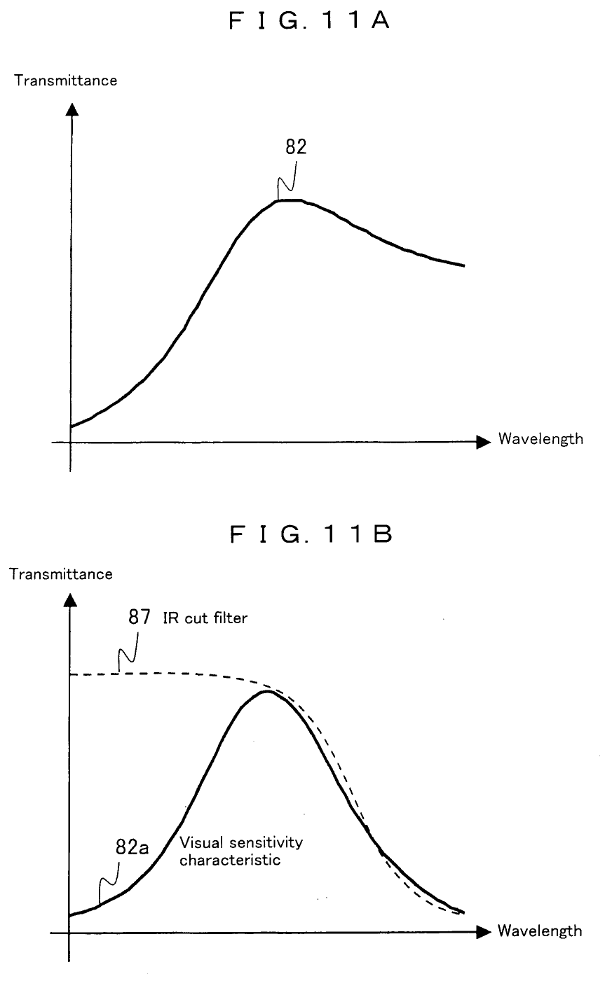

FIG. 11A is a graph shown extracting characteristic 82 of the color filter that is used in the above-described embodiment. FIG. 11B is a graph showing the characteristic 87 and the characteristic 82a. The characteristic 87 is the characteristic of the IR cut filter used in this embodiment, and the characteristic 82a is the combined characteristic of both the color filter 82 and the IR cut filter. The horizontal axes (wavelengths) of these graphs correspond to the range of 400 nm-700 nm to that human beings have a visible sensitivity, and the vertical axes thereof correspond to the transmittance.

Roughly speaking, the optical image from the subject reaches the light-receiving cell through the optical system constituted with the IR cut filter and the color filter. Thus, the transmission characteristic for each wavelength that reaches from the subject to the light-receiving cell is the characteristic 82a. The characteristic 82a almost matches with the visual sensitivity characteristic of human beings with respect to the luminance, so that the characteristic 82a can be handled approximately as the visual sensitivity characteristic. Therefore, the following Expression 3 can be found based on Expression 2 described above.
(R(red))=(AR*Iα)+(BR*Iβ)+(ΓR*Iγ)
(Y(luminance))=(0*Iα)+(BY*Iβ)+(0*Iγ)
(B(blue))=(AB*Iα)+(BB*Iβ)+(ΓB*Iγ) [Expression 3]

In the expression for finding the luminance signal of Expression 3, the coefficients except for the second color component β is the image pickup signal are 0, and only BY has the value that is not 0. By doing this, it is possible to reduce the circuit part of the operation unit that outputs the luminance signal, and to obtain a preferable signal that is also close to the visual sensitivity characteristic of human beings for the luminance.

(2) Modification Example

In the above, the transmission characteristic of the incident light that has reached the light-receiving cell has been explained as the visual sensitivity characteristic of human beings for the luminance. However, it is needless to say that the present invention is not limited to that. It may be the optical system whose transmission characteristic is equal to R (red), G (green), B (blue), W (achromatic color), CY (cyan), MG (magenta), and YE (yellow).

Although it is omitted to be described above because it has less influences compared to the IR cut filter and the color filter, the optical lens that adjusts the optical magnification and the focal point also has different transmittance according to the different wavelengths. Thus, the characteristic of the incident light that reaches the light-receiving cell may be considered to include the characteristic of the optical lens. Further, the above-described characteristic of the incident light may be considered to include the light transmittance of the semiconductor that constitutes the optical lens.

Further, the color matrix circuit 52 in the above is set to output R (red), Y (luminance) and B (blue), however, it may be set to output other signals such as the luminance signal IY and the color difference signals ICB (=B−Y) and ICR (=R−Y). Further, BY may be 1 or less or larger than 1, as long as it is not 0.

Furthermore, the filter having the spectral characteristic that is almost consistent with the visual sensitivity characteristic of human beings for the luminance shown in FIG. 11A and FIG. 11B may correspond to the position of G in the array unit of the Bayer array, and the filter having other characteristic may be arranged at the positions of R and G in the array unit of the Bayer array. By doing this, the frequency characteristic of the luminance signal is improved so that it is preferable for obtaining the image with much higher resolution.

### Fourth Embodiment

Next, explanation will be given to the electronic still camera according to a fourth embodiment of the present invention. The electronic still camera of this embodiment comprises almost the same structures as the electronic still camera of the first embodiment. However, they are different in terms of the arrangement of the color filters provided on the photoelectrical conversion elements of the image sensor, the YC processing circuit, and the color matrix circuit. Hereinafter, the fourth embodiment will be described by focusing attention to the difference.

(1) Arrangement of Color Filters

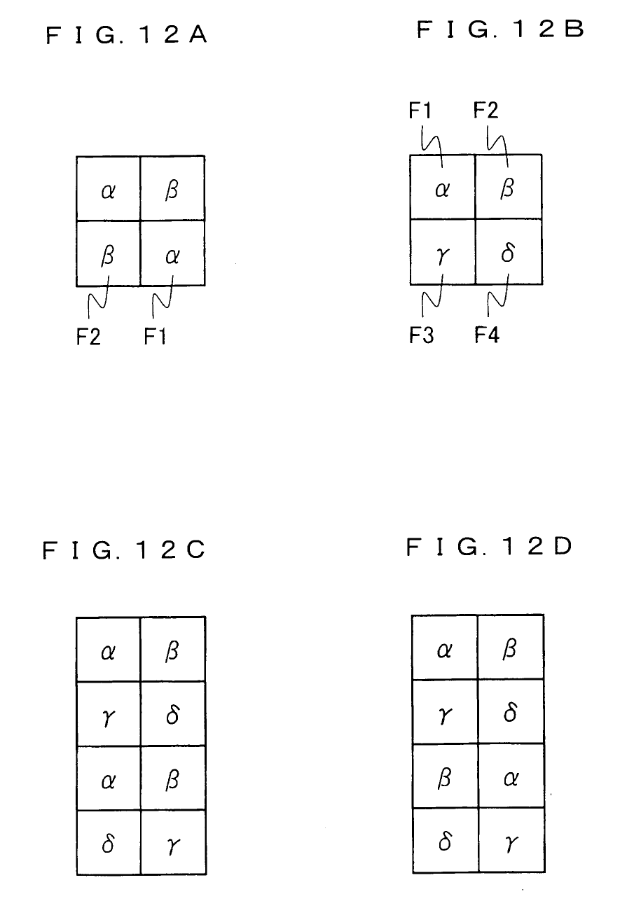

Except for the arrangement of the color filters, the structure of the image sensor according to this embodiment is almost the same as that of the first embodiment. Thus, the structure of the embodiment will be described only with respect to the arrangement of the color filter not about the structure of the image sensor. FIG. 12A shows the arrangement of the color filters of this embodiment. As shown in FIG. 12A, the color filters of this embodiment is provided with an array unit of two lines and two columns constituted with a filter F1 for the first color component α and a filter F2 for the second color component β. For the light transmission characteristics of each color filter, the characteristic 82 and the characteristic 83 of FIG. 8 are employed, respectively.

(2) YC Processing Circuit

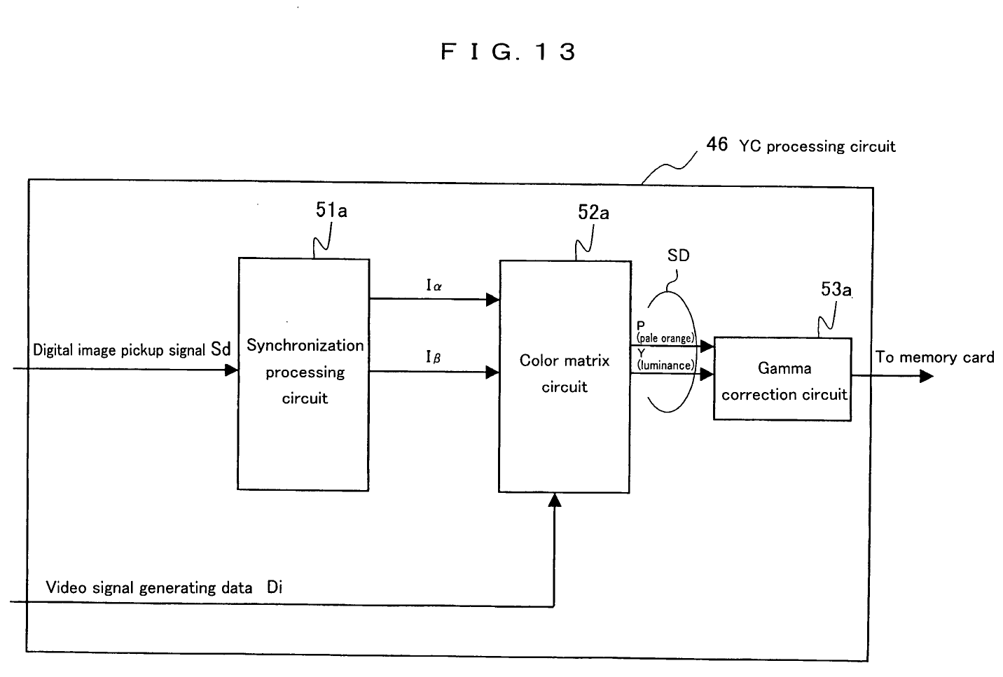

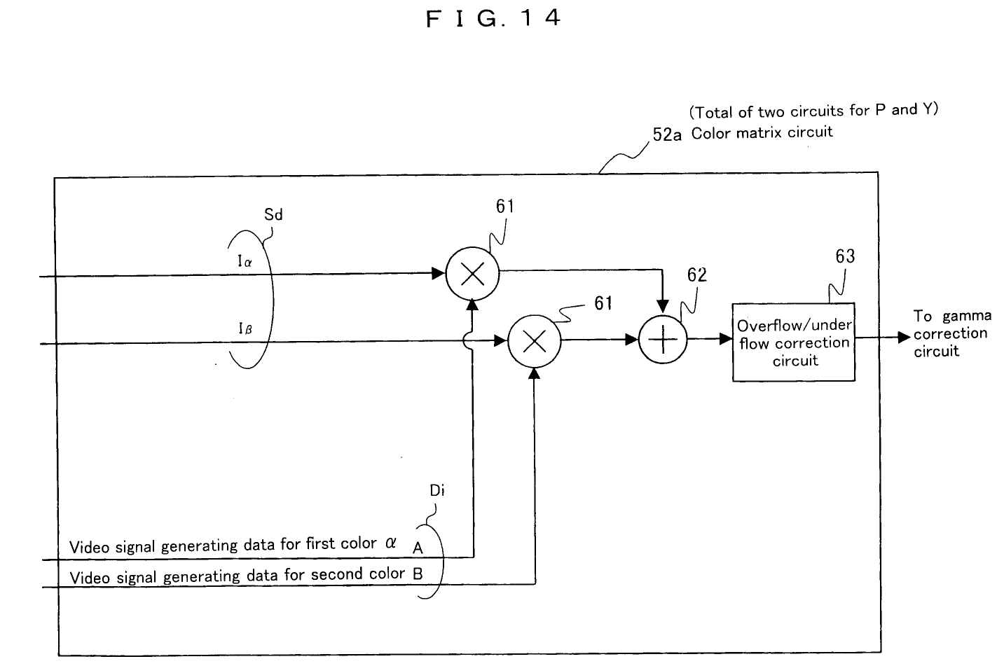

FIG. 13 is a block diagram for showing the structure of the YC processing circuit 46. The YC processing circuit 46 comprises a synchronization processing circuit 51a, a color matrix circuit 52a, and a gamma correction circuit 53a. The synchronization processing circuit 51a performs synchronization of the digital image pickup signal Sd by each of the color components α and β. The color matrix circuit 52a generates and outputs the digital video signal SD constituted with two colors of P (pale orange)and Y (luminance) by performing the arithmetic operation of the video signal generating data Di and the digital image pickup signal Sd that is synchronized by each color component in the synchronization processing circuit 51a. The gamma correction circuit 53a outputs the digital video signal SD by converting it to have the inverse characteristic of the gamma characteristic.

(3) Color Matrix Circuit

FIG. 14 is a block diagram for showing a part of the structure of the color matrix circuit 52a. The color matrix circuit 52a has a structure provided with the two circuits shown in FIG. 14 for generating P (pale orange) and Y (luminance). Each of the circuits comprises a multiplier 61, an adder 62, and an overflow/underflow correction circuit 63.

Flow of the processing will be described referring to one of the two circuits mentioned above as an example. First, the multiplier 61 multiplies each of the color signals Iα, Iβ of the respective color components α, β of the digital image pickup signal Sd that is synchronized by the synchronization processing circuit 51, by the video signal generating data A, B. The video signal generating data A is the data for the first component, and the video signal generating data B is the data for the second component.

The adder 62 adds the two multiplication results obtained in the multiplier 61. The adding result by the adder 62 is expressed by Expression 4.
(Output of Adder 62)=(A*Iα)+(B*Iβ) [Expression 4]

By the way, the adding result by the adder 62 in Expression 4 that is equivalent to the circuit shown in FIG. 14 corresponds to P (pale orange) and Y (luminance) outputted from the color matrix circuit 52a. Thus, Expression 5 is obtained from the relationship between Expression 4 and the output signals of the color matrix circuit 52a.
(P(pale orange))=(AP*Iα)+(BP*Iβ)
(Y(luminance))=(AY*Iα)+(BY*Iβ) [Expression 5]

Here, AP and AY are the coefficients to be multiplied to the color signal Iα of the digital image pickup signal Sd (has already been synchronized) for outputting P (pale orange) and Y (luminance), respectively. BP and BY are the coefficients to be multiplied to the color signal Iβ for outputting P (pale orange) and Y (luminance), respectively.

The overflow/underflow correction circuit 63 performs clipping processing when the adding result by the adder 62 obtained from Expression 4 exceeds a prescribed bit range, so as to correct it to be within the prescribed bit range.

According to the above-described structure, it is possible to obtain the luminance information that is close to the visual sensitivity characteristic of human beings from the filter of the first color component α, and to obtain the luminance information close to pale orange between yellow and red from the filter of the second color component β. It is not possible in this embodiment to properly obtain the color information felt by human beings. However, it is preferable as a means for recognizing an object that has a characteristic color component, for example, such as detection of the skin color at the time of detecting a person.

(4) Modification Example

In the above-described embodiment, the characteristics of the video signal outputted from the color matrix circuit 52a are set as pale orange and luminance. However, it is needless to say that the present invention is not limited to those but may output other signals or may output a single kind of signal such as the luminance signal alone. For the color filter, any type can be used for performing this embodiment as long as it is made of a single-layer inorganic material and has two kinds of transmission characteristics. Further, arrangement of the color filters may be set to be a so-called stripe form having one line and two columns as an array unit.

### Fifth Embodiment

Next, explanation will be given to the electronic still camera according to a fifth embodiment of the present invention. The electronic still camera of this embodiment comprises almost the same structures as the electronic still camera of the first embodiment. However, they are different in terms of the arrangement of the color filters provided on the photoelectrical conversion elements of the image sensor, the YC processing circuit, and the color matrix circuit. Hereinafter, the fifth embodiment will be described by focusing attention to the difference.

(1) Arrangement of Color Filters

Except for the arrangement of the color filters, the structure of the image sensor according to this embodiment is almost the same structure as that of the first embodiment. Thus, the structure of the embodiment will be described referring only to the arrangement of the color filter not about the structure of the image sensor. FIG. 12B shows the arrangement of the color filters of this embodiment. As shown in FIG. 12B, the color filters of this embodiment is provided with an array unit of two lines and two columns constituted with a filter F1 for the first color component α, a filter F2 for the second color component β, a filter F3 for the third color component γ, and a filter F4 for the fourth color component δ. For the light transmission characteristics of each color filter, the characteristics 81, 82, 83, and 80 shown in FIG. 8 are employed, respectively.

In other words, this color filter is provided with four kinds of film thickness, each of which having a particular maximum wavelength in the transmission spectrum, and the filters having the first film thickness and the second film thickness are arranged in order in the first line and the filters having the third film thickness and the fourth film thickness are arranged in order in the second line. This corresponds to a checkered-type complementary color array.

(2) YC Processing Circuit

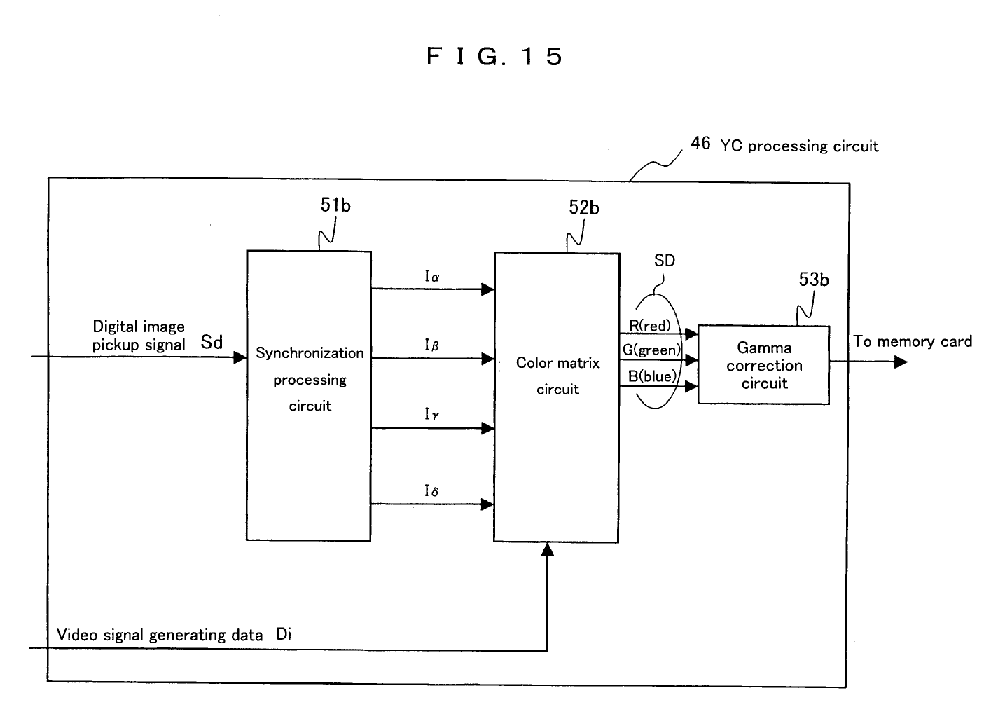

FIG. 15 is a block diagram for showing the structure of the YC processing circuit 46. The YC processing circuit 46 comprises a synchronization processing circuit 51b, a color matrix circuit 52b, and a gamma correction circuit 53b. The synchronization processing circuit 51b performs synchronization of the digital image pickup signal Sd by each of the color components α, β, γ, δ. The color matrix circuit 52b generates and outputs the digital video signal SD constituted with three colors of R (red), G (green), and B (blue) by performing the arithmetic operation of the video signal generating data Di and the digital image pickup signal Sd that is synchronized by each color component in the synchronization processing circuit 51b . The gamma correction circuit 53b outputs the digital video signal SD by converting it to have the inverse characteristic of the gamma characteristic.

(3) Color Matrix Circuit

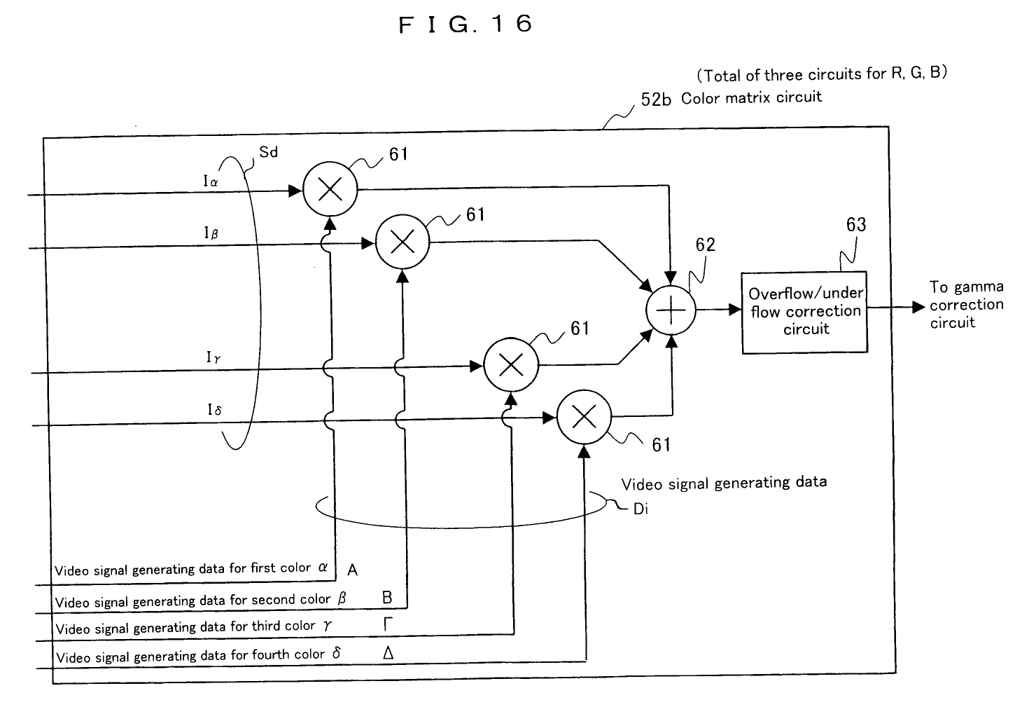

FIG. 16 is a block diagram for showing a part of the structure of the color matrix circuit 52b. The color matrix circuit 52b has a structure provided with the three circuits shown in FIG. 16 for generating R (red), G (green), and B (blue). Each of the circuits comprises a multiplier 61, an adder 62, and an overflow/underflow correction circuit 63.

Flow of the processing will be described referring to one out of the three circuits mentioned above as an example. First, the multiplier 61 multiplies each of the color signals Iα, Iβ, Iγ, Iδ of the respective color components α, β, γ, δ of the digital image pickup signal Sd (has been synchronized), by the video signal generating data A, B, Γ, Δ.

The adder 62 adds the four multiplication results by the multiplier 61. The adding result by the adder 62 can be expressed in Expression 6.
(Adding Result of Adder 62)=(A*Iα)+(B*Iβ)+(Γ*Iγ)+(Δ*Iδ) [Expression 6]

The adding result by the adder 62 obtained from Expression 6 that is equivalent to the circuit shown in FIG. 16 corresponds to R (red), G (green), and B (blue) outputted from the color matrix circuit 52b. Thus, Expression 7 is obtained from the relationship between Expression 6 and the output signals of the color matrix circuit 52b.
(R(red))=(AR*Iα)+(BR*Iβ)+(ΓR*Iγ)+(ΔR*Iδ)
(G(green))=(AG*Iα)+(BG*Iβ)+(ΓG*Iγ)+(ΔG*Iδ)
(B(blue))=(AB*Iα)+(BB*Iβ)+(ΓB*Iγ)+(ΔB*Iδ) [Expression 7]

Here, AR, AG, and AB are the coefficients to be multiplied to the color signal Iα of the digital image pickup signal Sd (has already been synchronized) for outputting R (red), G (green), and B (blue), respectively. BR, BG, and BB are the coefficients to be multiplied to the color signal Iβ for outputting R (red), G (green), and B (blue), respectively. ΓR, ΓR and ΓR are the coefficients to be multiplied to the color signal Iγ for outputting R (red), G (green), and B (blue), respectively. ΔR, ΔG and ΔB are the coefficients to be multiplied to the color signal Iδ for outputting R (red), G (green), and B (blue), respectively.

The overflow/underflow correction circuit 63 performs clipping processing so as to correct the adding result to be within the prescribed bit range, when the adding result by the adder 62 obtained from Expression 6 exceeds a prescribed bit range.

According to the above-described structure, it is possible to generate the desired R (red), G (green), and B (blue) signals from the image sensor (has the light transmission characteristic that is remarkably different from that of the conventional primary- and complementary-color filters) which comprises the color filter made of a single-layer inorganic material according to the present invention. Particularly, by disposing four kinds of the color filters in the image sensor, it is possible to increase the degree of freedom in generating the signals as shown by Expression 7, thereby achieving preferable color regeneration to a greater extent. Further, the affinity for those corresponding to the output of image pickup element in a conventional checkered-type complementary color array can be improved, so that the number of designing steps can be reduced remarkably.

(4) Modification Example

In the embodiment described above, the arrangement of the color filters is made to be the structure as shown in FIG. 12B. However, it is needless to say that the present invention is not limited to that. The arrangement of the color filters may be set in the four lines and two columns as an array unit, as shown in FIG. 12C and FIG. 12D.

The color filter shown in FIG. 12C is provided with four kinds of film thickness each of which has a particular maximum wavelength in the transmission spectrum, and the filters having the first film thickness, the second film thickness, the first film thickness, and the fourth film thickness are arranged in order (αγαδ) in the first column and the filters having the third film thickness, the fourth film thickness, the third film thickness, and the second film thickness are arranged in order (βδβγ) in the second column. This corresponds to a movie-type complementary color array.

By doing this, as the affinity for those corresponding to the output of image pickup element in a conventional movie-type complementary color array can be improved, the number of designing steps can be reduced remarkably.

Further, the color filter shown in FIG. 12D is provided with four kinds of film thicknesses each of which having a particular maximum wavelength in the transmission spectrum, and the filters having the first film thickness, the second film thickness, the third film thickness, and the fourth film thickness are arranged in order (αγβδ) in the first column, and the filters having the third film thickness, the fourth film thickness, the first film thickness, and the second film thickness are arranged in order (βδαγ) in the second column. This corresponds to an all-line inversion movie-type complementary color array.

By doing this, as the affinity for those corresponding to the output of image pickup element in a conventional all-line inversion movie-type complementary color array can be improved, the number of designing steps can be reduced remarkably. Like this, this embodiment is capable of changing the frequency band of the subject that can be picked up through adjusting the characteristics of the color filters. Thus, the color filters can be used selectively in accordance with the conditions such as the mode of the subject and the color components. Further, in the above description, the output signals are explained as three kinds, i.e. R (red) , G (green), and B (blue). However, the signals may be a combination of Y (luminance), CB (color difference of B−Y), CR (color difference of R−Y) and the like, or may be a single kind, only Y (luminance). Furthermore, the output may be four or more kinds such as R (red), G (green), B (blue), and Y (luminance).

Further, though the film thickness in the color filter is explained as four kinds in the present embodiment described above, it may be four or more kinds. Such cases can be achieved by adding terms as in α, β, γ, δ - - - , to Expression 6 and Expression 7. By doing this, more fine color regeneration can be achieved.

### Sixth Embodiment

Next, the electronic still camera will be described according to a sixth embodiment of the present invention. The electronic still camera of this embodiment comprises almost the same structures as the electronic still camera of the first embodiment. However, they are different in terms of the structure of the YC processing circuit. Hereinafter, the sixth embodiment will be described by focusing attention to the difference.

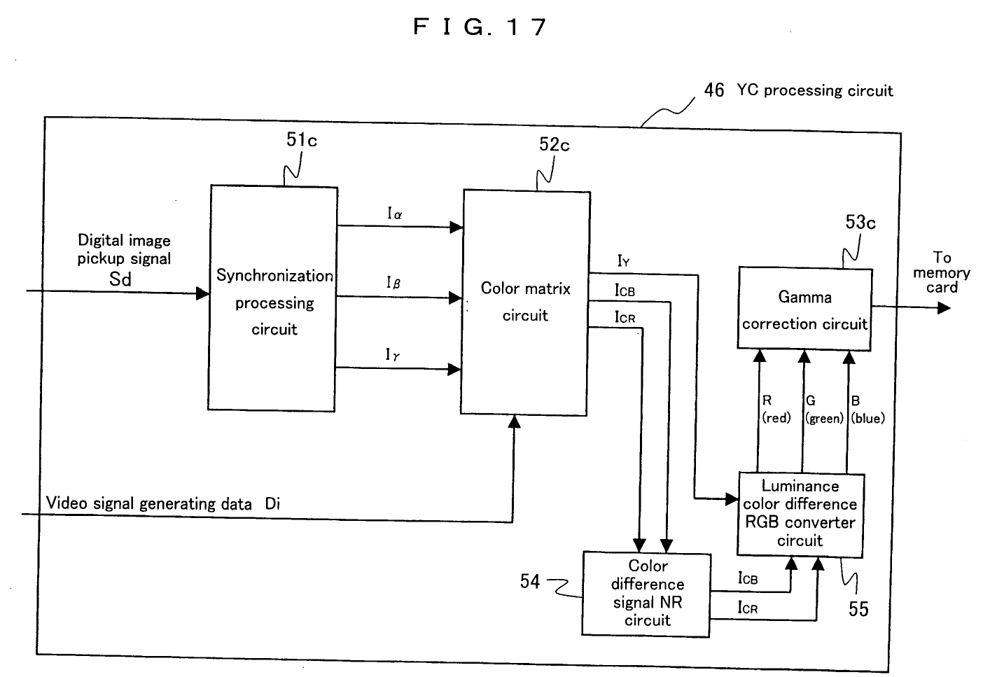

FIG. 17 is a block diagram for showing the structure of the YC processing circuit 46. The YC processing circuit 46 comprises a synchronization processing circuit 51c, a color matrix circuit 52c, a gamma correction circuit 53c, a color difference signal NR (Noise Reduction) circuit 54, and a luminance color difference RGB converter circuit 55.

The synchronization processing circuit 51c performs synchronization of the digital image pickup signal Sd by each of the color components α, β, γ. The color matrix circuit 52c performs the arithmetic operation of the video signal generating data Di and the digital image pickup signal Sd (has been synchronized) to generate and output the digital video signal SD constituted with three systems of the luminance signal IY, the color difference signal ICB, and the color difference signal ICR. The gamma correction circuit 53c outputs the digital video signal SD by converting it to have the inverse characteristic of the gamma characteristic. The color difference signal NR circuit 54 outputs the color difference signal after carrying out the processing to reduce the noise or the sense of noise. The luminance color difference GBR converter circuit 55 generates and outputs the signals of RGB (red, green, blue) by performing the arithmetic operation according to the luminance signal and the two kinds of color difference signals ICB and ICR.

(2) Color Difference Signal NR circuit

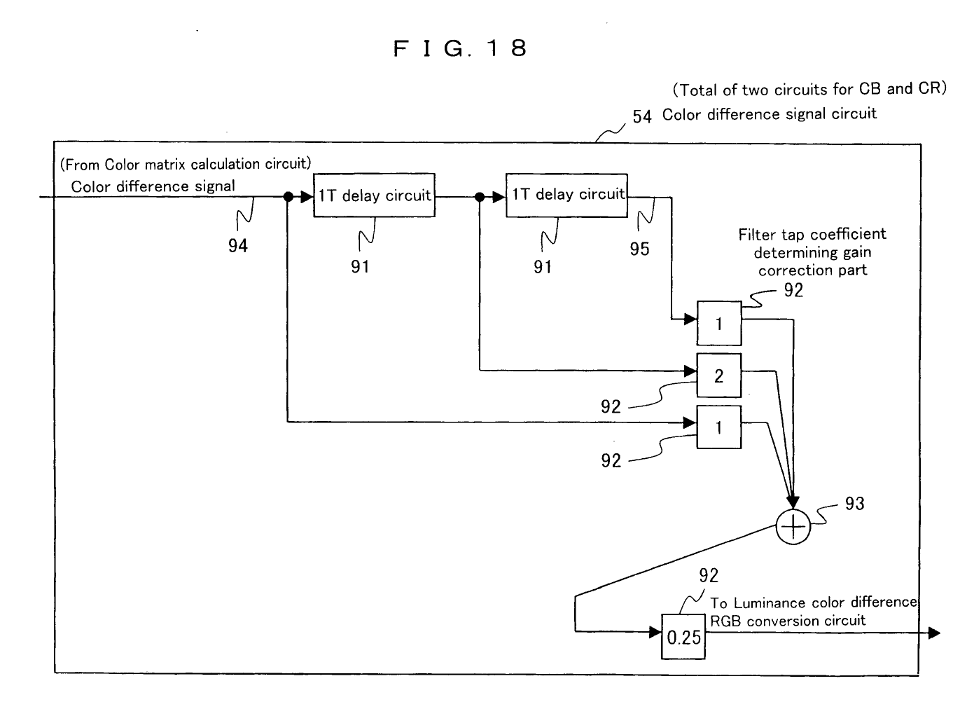

The color difference signal NR circuit 54 is constituted with two circuits arranged in parallel as shown in FIG. 18 for the color difference signal ICB and for the color difference signal ICR in order to perform processing of the two kinds of color difference signals. Each of the circuits comprises a 1T delay circuit 91, a filter tap coefficient determining gain correction part 92, and an adder 93.

The 1T delay circuit 91 outputs the inputted data with a delay of one period of the clock synchronizing signal, in accordance with the clock synchronizing signal (not shown) supplied to the 1T delay circuit 91. Thus, there is a time lag of two periods between the signal 94 and the signal 95. When the image pickup signals are processed by synchronizing with the clock synchronizing signal, the signal 95 corresponds to the image pickup signal that is two pixels away from the pixel of the signal 94.

Further, the filter tap coefficient determining gain correction parts 92 have the correction gain values that are the inside numbers surrounded by the squares area as shown in the drawing. For example, when the value inside the square area is 0.25, the relationship of Expression 8 is established between the input and output of the filter tap coefficient determining gain correction part 92.
(Output)=(0.25)*(Input) [Expression 8]

Furthermore, the adder 93 adds the image pickup signal delayed by the 1T delay circuit 91 and the signals that are gain-corrected by each of the filter tap coefficient determining gain correction parts 92. According to this, by setting a certain pixel as a reference pixel, it becomes possible to output the signals which are obtained by performing the gain correction of 0.25 times on the adding results of the followings, after adding the weight of 2:1:1, respectively between them as follows.
the reference pixel and the reference pixel
the adjacent pixel to the reference pixel in a first direction setting the reference pixel as an original point and the reference pixel
the adjacent pixel of the reference pixel in a direction that is different by 180° from the first direction setting the reference pixel as an original point and the reference pixel

As the adding results with the weight of “2:1:1” indicate the filter processing by LFP, the high frequency component of the color difference signal is decreased and only the low frequency component is transmitted through. Therefore, it is possible to obtain the high-quality signals with the sense of noise being suppressed in the color difference signal.

(3) Luminance Color Difference RGB Converter Circuit

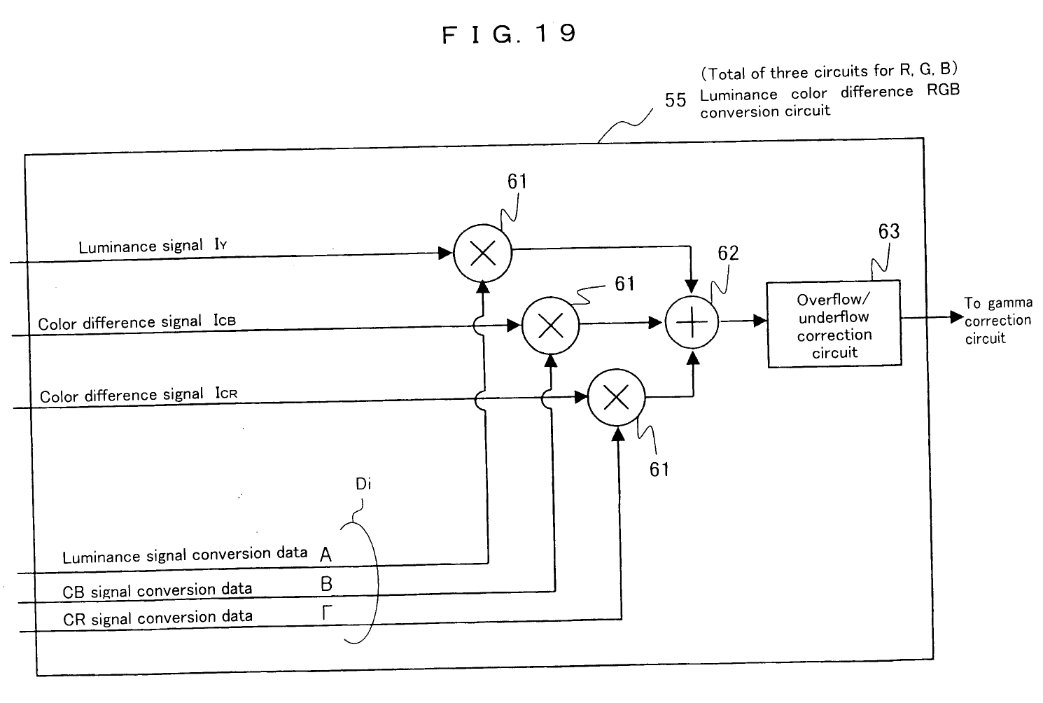

FIG. 19 is a block diagram for showing a part of the luminance color difference RGB converter circuit 55. The luminance color difference RGB converter circuit 55 is constituted with three circuits shown in FIG. 19 for generating R (red), G (green), and B (blue) from the luminance signal IY, the color difference signal ICB, and the color difference signal ICR. Each of the circuits comprises a multiplier 61, an adder 6, and an overflow/underflow correction circuit 63.

Flow of the processing will be described referring to one of the three circuits mentioned above as an example. First, the multiplier 61 multiplies each of the luminance signals IY, the color difference signal ICB and the color difference signal ICR by the video signal generating data (luminance signal conversion data) A, the video signal generating data (CB signal conversion data) B, the video signal generating data (CR signal conversion data)Γ.

The adder 62 adds the three multiplication results by the multiplier 61. The adding result by the adder 62 is expressed in Expression 9.
(Output of Adder 62)=(A*IY)+(B*ICB)+(Γ*ICR) [Expression 9]

The output of the adder 62 obtained from Expression 9 that is equivalent to the circuit shown in FIG. 19 corresponds to R (red), G (green), and B (blue) outputted from the luminance color difference RGB converter circuit 55. Thus, Expression 10 is obtained from the relationship between Expression 9 and the output signals of the luminance color difference RGB converter circuit 55.
(R(red))=(AR*IY)+(BR*ICB)+(ΓR*ICR)
(G(green))=(AG*IY)+(BG*ICB)+(ΓG*ICR)
(B(blue))=(AB*IY)+(BB*ICB)+(ΓB*ICR) [Expression 10]

AR, AG, and AB are the coefficients to be multiplied to the luminance signal IY for outputting R (red), G (green), and B (blue), respectively. BR, BG, and BB are the coefficients to be multiplied to the color difference signal ICB for outputting R (red), G (green), and B (blue), respectively. ΓR, ΓR and ΓR are the coefficients to be multiplied to the color difference signal ICR for outputting R (red), G (green), and B (blue), respectively.

The overflow/underflow correction circuit 63 performs clipping processing to correct the adding result to be within the prescribed bit range when the adding result of the adder 62 obtained from Expression 9 exceeds a prescribed bit range.

It is preferable for the values set in the luminance color difference RGB converter circuit 55 to satisfy the relation shown in Expression 11.
R(red)=IY+ICR
G(green)=IY−0.5*ICR−0.18*ICB
B(blue)=IY+ICB [Expression 11]

(4) Modification Example

In the description of this embodiment provided above, two color difference signal NR circuits 54 are arranged in parallel so as to correspond to two kinds of color difference signals. However, it is needless to say that the present invention is not limited to that. For example, the two color signals may be processed alternately in a time series by a single color difference signal NR circuit by thinning out the color difference signals.

Further, in the explanation of this embodiment mentioned above, LPF is used as a structure for executing NR (noise reduction). However, a rank filter, typically a median filter, may be used.

Furthermore, though the embodiment comprises both the luminance color signal RGB converter circuit 55 and the color matrix circuit 52c, they may be rationalized into a single circuit by taking advantage of the similarity in the circuit structures.

Moreover, the coefficients used in Expression 11 for converting the luminance color difference signals to the RGB signals are merely examples, and other values may be used as well.

### Seventh Embodiment

Next, the electronic still camera will be described according to a seventh embodiment of the present invention. The electronic still camera of this embodiment comprises almost the same structures as the electronic still camera of the first embodiment. However, they are different in terms of the structure of the YC processing circuit. Hereinafter, the seventh embodiment will be described by focusing attention to the difference.

(1) Color Matrix Circuit

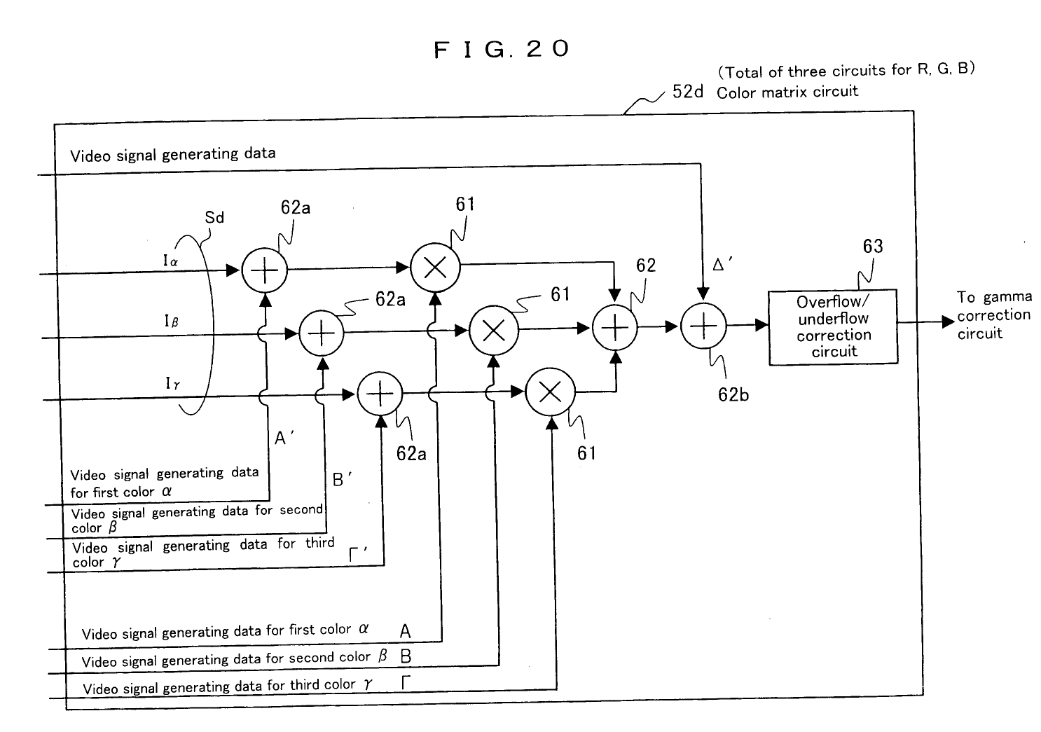

FIG. 20 is a block diagram for showing a part of the structure of the color matrix circuit 52d. The color matrix circuit 52d has a structure provided with three circuits shown in FIG. 20 for generating R (red), G (green), and B (blue). Each of the circuits comprises a multiplier 61, an adder 62, an overflow/underflow correction circuit 63, an adder 62a, and an adder 62b.

Flow of the processing will be described referring to one of the three circuits mentioned above as an example. First, the adder 62a adds the video signal generating data A′, B′, Γ′, respectively, to each of the color signal Iα, Iβ, Iγ of the color components α, β, γ in the digital image pickup signal Sd (has been synchronized).

Then, the multiplier 61 multiplies each of (Iα+A′), (Iβ+B′), and (Iγ+Γ′) of the digital image pickup signal Sd (has been synchronized) to which the prescribed values have been added by the adder 62a, respectively by the respective video signal generating data A, B, Γ.

Subsequently, the adder 62 adds the three multiplication results obtained in the multiplier 61. Then, the adder 62b adds the digital image pickup signal Sd added in the adder 62 and the video signal generating data Δ′ inputted from the micro computer 45. The adding result of the adder 62b can be expressed in Expression 12.
(Adding Result of Adder 62)=(A*(Iα+A′))+(B*(Iβ+B′)) +(Γ*(Iγ+Γ′))+Δ′ [Expression 12]

The adding result of the adder 62b obtained from Expression 12 that is equivalent to the circuit shown in FIG. 20 corresponds to R (red), G (green), and B (blue) outputted from the color matrix circuit 52d. Thus, Expression 13 is obtained from the relationship between Expression 12 and the output signals of the color matrix circuit 52d.
(R(red))=(AR*(Iα+A′R))+(BR*(Iβ+B′R))+(ΓR*(Iγ+Γ′R))+Δ′R
(G(green))=(AG*(Iα+A′G))+(BG*(Iβ+B′G))+(ΓG*(Iγ+Γ′G))+Δ′G
(B(blue))=(AB*(Iα+A′B))+(BB*(Iβ+B′B))+(ΓB*(Iγ+Γ′B))+Δ′B [Expression 13]

A′R, A′G, and A′B are the coefficients to be added to the color signal Iα of the digital image pickup signal Sd (has already been synchronized) for outputting R (red), G (green), and B (blue), respectively. B′R, B′G, and B′B are the coefficients to be added to the color signal Iβ for outputting R (red), G (green), and B (blue), respectively. Γ′R, Γ′R and Γ′R are the coefficients to be added to the color signal Iγ for outputting R (red), G (green), and B (blue), respectively. AR, AG, and AB are coefficients to be multiplied to the image pickup signal (Iα+A′) outputted from the adder 62a for outputting R (red), G (green), and B (blue), respectively. BR, BG, and BB are coefficients to be multiplied to the image pickup signal (Iβ+B′) outputted from the adder 62a for outputting R (red), G (green), and B (blue), respectively. ΓR, ΓG, and ΓB are coefficients to be multiplied to the image pickup signal (Iγ+Γ′) outputted from the adder 62a for outputting R (red), G (green), and B (blue), respectively. Δ′R, Δ′R and Δ′R are the coefficients to be added to the image pickup signal (A* (Iα+A′)+B*(Iβ+B′)+Γ*(Iγ+Γ′)) outputted from the adder 62 for outputting R (red), G (green), and B (blue), respectively.

The overflow/underflow correction circuit 63 performs clipping processing to correct the adding result to be within the prescribed bit range, when the adding result of the adder 62 obtained from Expression 13 exceeds a prescribed bit range.

(2) Modification Example

In the embodiment described above, though the values A′, B′, and Γ′ added to the image pickup signals are set separately, it is needless to say that the present invention is not limited to that. The values A′, B′, and Γ′ may be the same values or negative values. It is the same for the value Δ′, and the values Δ′R, Δ′G, Δ′B may be the separate values or the same values. Further, a negative value may be included. Furthermore, a multiplier (not shown) may be provided for correcting the gain of the output from the adder 62b.

According to the embodiment, as conversion expressed by adding or subtracting the constant with respect to the linear combination expression of the digital image pickup signal Sd, is performed, it is possible to perform intimate adjustment on the digital video signal SD. Furthermore, the redundant circuit can be omitted so that the scale of the circuit can be reduced.

### Eighth Embodiment

Next, the electronic still camera will be described according to an eighth embodiment of the present invention. The electronic still camera of this embodiment comprises almost the same structures as the electronic still camera of the fourth embodiment. However, they are different in respect that there is no IR cut filter provided between the optical lens and the image sensor, and that there are differences also in the light transmission characteristics of the color filters and in the structures of the color matrix circuits. hereinafter, the embodiment will be described by focusing attention to the differences.

(1) Structure of Electronic Still Camera (With or without IR Cut Filter)

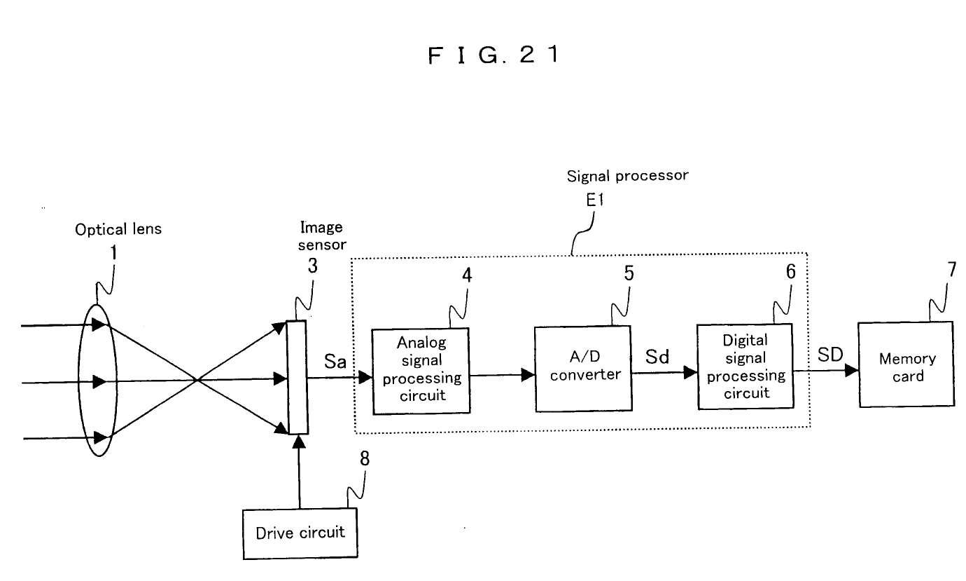

FIG. 21 is a block diagram for showing the functional structure of the electronic still camera according to this embodiment. As shown in FIG. 21, the electronic still camera of this embodiment comprises an optical lens 1, an image sensor 3, an analog signal processing circuit 4, an A/D. converter 5, a digital signal processing circuit 6, a memory card 7, and a drive circuit 8. However, the IR cut out filter 2 in the structure shown in FIG. 1 is not provided in this embodiment.

The optical lens 1 forms an image of the incident light from a subject on the image sensor 3. Since there is no IR cut out filter in the electronic still camera of this embodiment, the long wavelength components of the light entered on the image sensor 3 are not eliminated. The image sensor is a so-called single-plate CCD image sensor. Consequently, in the embodiment, a single-color filter is provided for filtering the incident light entered to each of the photoelectrical conversion elements that are arranged two-dimensionally. The image sensor 3 reads out the electric charge according to the drive signal from the drive circuit 8, and outputs the analog image pickup signal Sa.

The analog signal processing circuit 4 performs processing such as correlation double sampling and signal amplification on the analog image pickup signal Sa outputted from the image sensor 3. The A/D converter 5 converts the output signal of the analog signal processing circuit 4 into a digital image pickup signal Sd. The digital signal processing circuit 6 generates a desired digital video signal SD based on the digital image pickup signal Sd. The digital video signal SD outputted from the digital signal processing circuit 6 is recorded in the memory card 7.

(2) Arrangement and Light Transmission Characteristic of Color Filter

The structure of the image sensor according to this embodiment has almost the same as that of the first embodiment except for the arrangement of the color filters. Thus, this embodiment is described with respect to the arrangement of the color filters and the light transmission characteristics thereof.

For the arrangement of the color filters, the structure shown in FIG. 12A is employed. The color filter of the image sensor according to this embodiment comprises the filter F1 for the first color component α and the filter F2 for the second color component β that are arranged in two lines and two columns as an array unit.

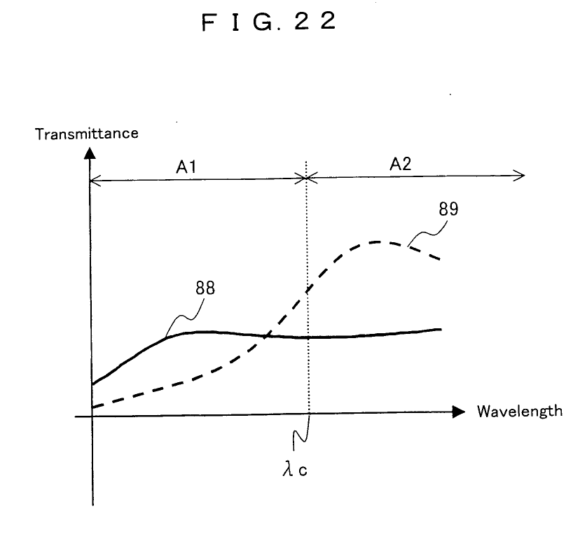

The light transmission characteristics of the first color component α and the second color component β of each color filter are the characteristic 88 and the characteristic 89 of FIG. 22, respectively. The horizontal axis of FIG. 22 corresponds to the wavelength and the vertical axis corresponds to the light transmittance.

λc is the cutoff wavelength of the IR cut filter provided in a conventional electronic still camera, A1 is the wavelength area used as the image pickup signals in the conventional electronic still camera, and A2 is the wavelength area that is not used as the image pickup signals due to light shielding by the IR cut filter. The area A1 and the area A2 are divided by the cutoff wavelength λc. In the electronic still camera of this embodiment, the area Al is the wavelength area of about 400 nm-about 700 nm, the area A2 is the wavelength area of about 700 nm or more, and the cutoff wavelength λc is set at about 700 nm. That is, the color filters of this embodiment transmit the light of the area A1 and that of the area A2 by each pixel address of the image sensor.

(3) Color Matrix Circuit

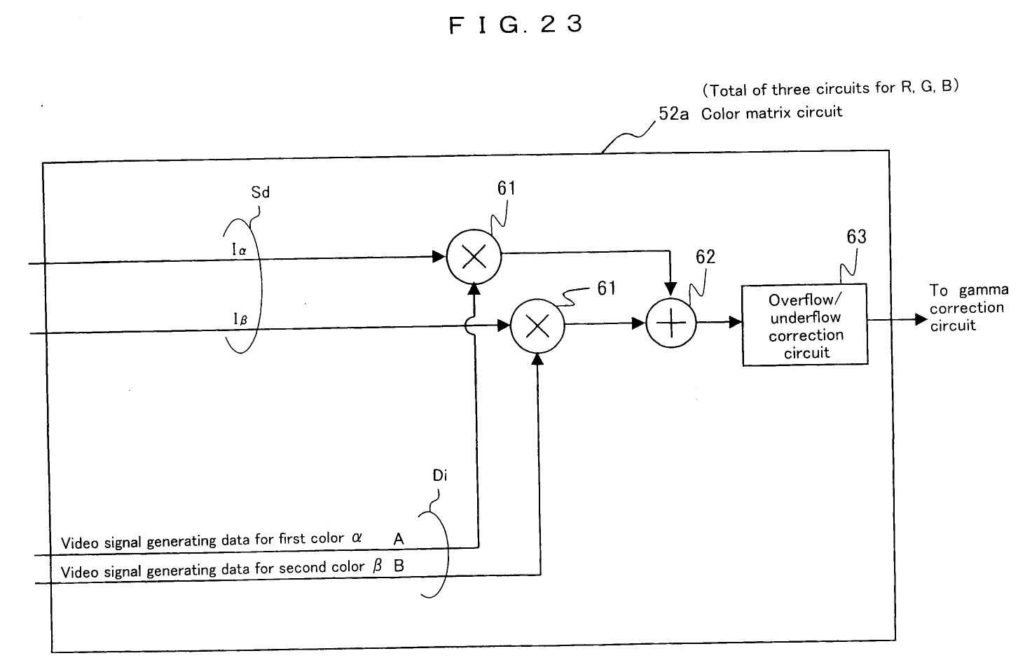

FIG. 23 is a block diagram for showing a part of the structure of the color matrix circuit 52a. The color matrix circuit 52a has a structure disposed with the two circuits shown in FIG. 23 for generating I (near infrared video)and Y (luminance). Each of the circuits comprises a multiplier 61, an adder 62, and an overflow/underflow correction circuit 63.

Flow of the processing will be described referring to one of the two circuits mentioned above as an example. First, the multiplier 61 multiplies each of the color signals Iα, Iβ of the respective color components α, β of the digital image pickup signal Sd (has been synchronized), by the video signal generating data A, B. The adder 62 adds the two multiplication results of the multiplier 61. The adding result of the adder 62 can be expressed in Expression 14.
(Adding Result of Adder 62)=(A*Iα)+(B*Iβ) [Expression 14]

The adding result of the adder 62 obtained from Expression 14 that is equivalent to the circuit shown in FIG. 23 corresponds to I (near infrared video) and Y (luminance) outputted from the color matrix circuit 52a. Thus, Expression 15 is obtained from the relationship between Expression 14 and the output signals of the color matrix circuit 52a.
(I(near infrared video))=(AI*Iα)+(BI*Iβ)
(Y(luminance))=(AY*Iα)+(BY*Iβ) [Expression 15]

Here, each of AI and AY is the coefficients to be multiplied to the color signal Iα of the digital image pickup signal Sd for outputting I (near infrared video) and Y (luminance) , and each of BI and BY is the coefficients to be multiplied to the color signal Iβ of the digital image pickup signal Sd for outputting I (near infrared video) and Y (luminance), respectively.

The overflow/underflow correction circuit 63 performs clipping processing so as to correct the adding result to be within the prescribed bit range when the adding result of the adder 62 obtained from Expression 15 exceeds a prescribed bit range.

Particularly, it is possible in the matrix circuit of this embodiment to obtain desired signals by satisfying the following relationship.
(I(near infrared video))=(AI*Iα)−(BI*Iβ)
(Y(luminance))=(−1)*(AY*Iα)+(BY*Iβ)
AI, BI, AY, BY>0 [Expression 16]

According to the above-described structure, it is possible to obtain the luminance information that is close to the visual sensitivity characteristic of human beings by subtracting the gain-corrected signal to the output from the filter for the second color component β from the gain-corrected signal to the output from the filter for the first color component α. Further, it is possible to obtain the video information close to the near infrared area by subtracting the gain-corrected signal to the output from the filter for the first color component α from the gain-corrected signal to the output from the filter for the second color component β.

It is not possible in this embodiment to properly obtain the color information sensed by a human being. However, it is preferable as a device for recognizing an object present in the low-luminance part and an object present in the high-luminance part respectively in the case of picking up the subjects that contain, for example, both a subject that extremely lacks in the light amount and a subject that has extremely excessive amount of light.

(4) Modification Example

In the above description, the characteristics of the video signals to be outputted are the luminance signal and the near infrared video signal. However, it is needless to say that the present invention is not limited to that. Other signals may be outputted, or a single kind of signal such as the luminance signal alone may be outputted.

It is the same for the arrangement of the color filter. The kinds of the film thickness are not limited to be two kinds as long as there is one kind or more.

The embodiment has no IR cut filter and is capable of utilizing the video signals of the near infrared area, so that the information amount of the image pickup signals can be increased.

### Ninth Embodiment

(1) Color Arrangement of Filter

It is needless to say that each of the first color component α, the second color component β, and the third color component λ can be arranged in any combinations in the color arrangement of the color filters according to each of the above-described embodiments. Nevertheless, when α/β/λ combine with red/yellow/achromatic color respectively, the best color S/N can be obtained. The reason will be described hereinafter.

As described above, the transmission characteristic is different from that of the color filter using an organic material in the structure of the present invention using a single-layer filter film made of an inorganic material. The transmission wavelength is determined with the product of the filter film thickness and the refractive index of the inorganic material at that film thickness. Thus, it becomes difficult to set the combination of the ideal reference color stimulus quantity defined by CIE (Commission Internationale de I'Eclairage), i. e. the combination of the stimulus quantity at the three kinds of ideal wavelengths 700 nm, 546.10 nm, and 435.8 nm of R (red), G (green), and B (blue).

When the maximum wavelengths of the transmission spectra are red=700 nm, yellow=575 nm, and achromatic color=435 nm (may be close to blue or near the boundary between visible light and ultraviolet light), it is easier to separate and transmit the light of those wavelengths. It is ideal for the maximum wavelengths to be the above-described values. However, in practice, there are differences in the wavelengths due to variations in manufacture of the solid-state image pickup elements, etc. Therefore, errors within a range of approximately ±50 nm are acceptable. That is, the respective maximum wavelengths may be within the ranges of: red=650 nm-750 nm, yellow=525 nm-625 nm, blue=380 nm-480 nm. Further, there is a high-pass transmission characteristic for the wavelengths, and it is desirable that the wavelength range of the maximum wavelengths in the color transmission spectra be included in the range of the transmission wavelengths. In that case, the cutoff frequency is desirable to be less than the maximum values since the maximum wavelengths are within the range of the transmission wavelengths.

As in the wavelength range described above, it is ideal to determine each of the film thickness uniformly in order from the thicker ones. However, in practice, there may cause differences in the film thickness due to the variations in manufacture of the solid-state image pickup elements. Thus, there may be a margin of errors within a range of about ±10. That is, the optimum film thickness at the wavelengths of 700 nm, 575 nm, and 435 nm calculated from the above-described expression, N·d=λ/2, become 70 nm, 60.5 nm, and 40 nm, respectively since the refractive indexes at those wavelengths are 5.25, 4.75 and 4.5. The above-described range of the wavelengths for each color exhibiting the maximum values are: red=650 nm-750 nm, yellow=525 nm-625 nm, blue=380 nm-480 nm so that, including the variations of about ±10 nm in the optimum film thickness, the color wavelengths of red, yellow, and achromatic color can be obtained as long as the film thickness are within the ranges of 30 nm-50 nm, 50 nm-70 nm, and 60 nm-100 nm under the consideration of a variation ±10 in the vicinity of the optimum film thickness.

The film thickness obtained from the above-described expression, N·d=λ/2, has a correlation between the wavelength and the refractive index, and it is proportional when the refractive index is constant. Thus, when the first color component, the second color component, and the third color component are arranged in order from the thicker one, the order would be red, yellow, and achromatic color.

Further, the RGB components are calculated in the YC processing circuit 46. Those can be expressed in the following relationship based on additive color mixture.
(R(red))=(R(red))
(G(green))=(R(red))−(Ye(yellow))
(B(blue))=(W(achromatic color)−(R(red))−(G(green))=(W(achromatic color))−(Ye(yellow)) [Expression 17]
That is, the color components of RGB can be calculated and determined only with those three of color components by using the color filters for red, yellow, and the achromatic color.

When the additive color mixture is applied to Expression 2 described above, it corresponds to the following case: AR=1, AG=1, AB=−1, BR=0, BG=1, BB=−1, ΓR=0, ΓG=0, ΓB=1. In other words, on an assumption that the correction values supplied from the micro computer 45 are the above-described nine values, it is not necessary for the micro computer 45 to supply the correction value and perform multiplication for calculating the color components of RGB in the color matrix circuit 52. Therefore, the circuit scale of the color matrix circuit 52 can be reduced, and thereby the cost reduction is achieved.

In the color matrix circuit 52, in practice, the color component that has no term in Expression 17 can be expressed as follows by setting the coefficient in Expression 2 as 0 and omitting the term to which the coefficient 0 is multiplied.

$$( R ( red ) ) = AR * ( R ( red ) ) \\ ( G ( green ) ) = AG * ( R ( red ) ) + BG * ( Ye ( yellow ) ) \\ \begin{matrix}( B ( blue ) ) = ( W ( achromatic color ) - ( R ( red ) ) - ( G ( green ) ) \\ = ( BB * ( Ye ( yellow ) ) + Γ B * ( W ( archomatic color ) )\end{matrix} \qquad [ Expression 18 ]$$

Unlike the color filter of the organic material, the light transmitting characteristics of the color filter made of the inorganic material do not have definite maximum wavelengths, and the signal levels of the wavelengths, which correspond to the maximum values of the spectra, become smaller as the wavelengths becomes shorter. As a result, the light transmission characteristic of the color filter made of the inorganic material has the cutoff characteristic that reflects the wave range on the shorter wavelength side than a certain wavelength without transmitting it. Thus, in the actual color matrix circuit 52, the coefficients multiplied to each signal in Expression 18 are used for adjusting the signal levels of each color component. Like this, the filter film of the present invention having the characteristics described above can improve the color regenerating ability by combining it with the digital signal processing circuit in which the coefficients multiplied to each signal on Expression 18 are set.

(2) Example of Filter Arrangement

In the filter structure where three kinds of different color components are arranged in four pixels of two lines and two columns, the solid-state image pickup element and an image input device with the most improved color S/N can be obtained by selecting and arranging two Ye components therein. The reason will be described below.

Qualitatively, the peak wavelength of the spectrum of the Ye component is about 575 nm and the maximum wavelength is located at the center of the visible light area comparing to those of the R component and the W component. Thus, the receivable wavelength ranges are distributed over a wide range of the visible light area including the vicinity of the maximum wavelength, so that the color sensitivity becomes the highest among the three components. Because of this, the best color S/N can be achieved by using two Ye components. Moreover, in the structure using the color filter of the inorganic material, there are cases with no notable maximum value in the visible light area and, in such structure, the effect of improvement in the color S/N ratio becomes more conspicuous as the wavelengths are shorter. Regarding white, the difference in the color S/N becomes much more evident statistically as the signal ratio of each color component becomes larger, in terms of the quantitative noise. Thus, this effect will be described referring to the case of regenerating white as an example.

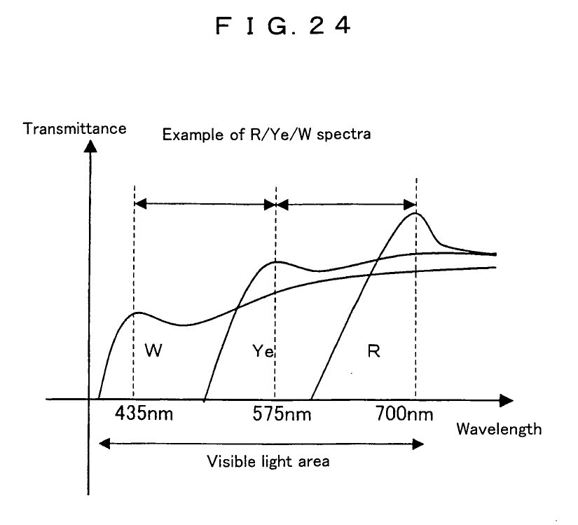

The signal ratios of R:W:Ye constituting white are expressed by the integral values in the visible light area of the transmission spectra. As in FIG. 24 showing the schematic view thereof, the maximum wavelength areas are almost at equal intervals as in 435 nm, 575 nm, and 700 nm. Thus, the integral values are 1:2:3 approximately. Needless to say, in practice, the ratio of the integral values is not only 1:2:3 but may also be different due to the transmission characteristic of the device, the film thickness or the like. Here, white is not the same signal as the W component but a different signal.

In Expression 17 described above, two terms of the R components and Ye components, and one term of W component are used for converting to RGB. However, the contribution ratio of the W component as one term is low to other components. Thus, even with two W components, the best color S/N cannot be obtained. Therefore, though either of the two kinds of filters, i.e. the filter for the R component and the filter for the Ye component is set two in array, the better color S/N can be achieved by selecting the two filters that have the smaller noise.

Further, not a little noise components is contained in the image data. Assuming that the noise components of R, Ye, and W are Nr, Nye, and Nw respectively, it becomes Nr:Nye:Nw=1:√2:√3, because the noise ratio is proportional to a square root (written √ as hereinafter) of the signal. √n is a square root of n, and √( - - - ) is a square root of ( - - - ).

When two filters for the R component are set, it becomes as follows.
Noise of R component=Nr/√2=√(0.5)
Noise of G component=√(Nr2/2+Nye2)=√(2.5)
Noise of B component=√(Nye2/2+Nw2)=√5
Noise of White=√((Noise of R)2+(Noise of G)2+(Noise of B)2)=√8

In the meantime, when two filters for the Ye component are set, it becomes as follows.
Noise of R component=Nr=1
Noise of G component=√(Nr2/2+Nye2/2)=√2
Noise of B component=√(Nye2/2+Nw2)=√4 =2
Noise of White=√((Noise of R)2+(Noise of G)2+(Noise of B)2)=√7

Because of the reasons described above, it is quantitatively evident that the noise amount is suppressed at a low level by the use of two Ye-component color filters in the color filters, so that the color S/N ratio can be improved also from the viewpoint of noise.

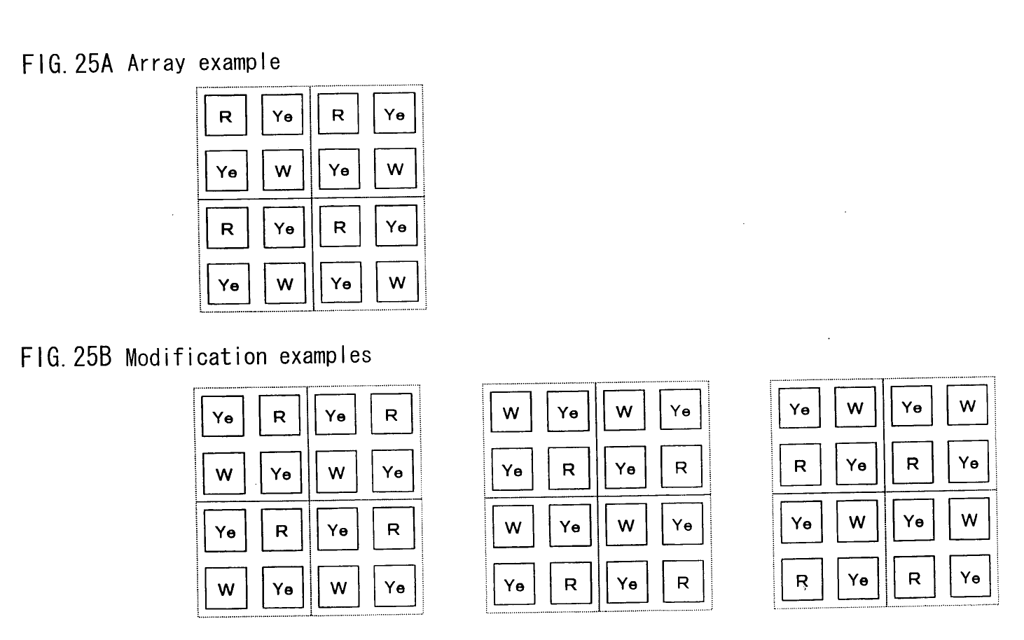

FIG. 25A and FIG. 25B show examples of the filter arrangement having 2×2 pixels as an array unit. The filters for Ye component are arranged in a checkered form. In FIG. 25A, those are arranged in order of the longer wavelength from the upper left towards the lateral direction, in which the R-component filter is arranged at the upper left of the pixel unit and the W-component filter is arranged at the lower right, respectively. However, it is the same when the pixel unit is shifted by one pixel in the top and bottom, left and right. In other words, as shown by the arrangement of each filter in FIG. 25B, the W-component filter may be arranged at the upper left of the pixel unit and the R-component filter may be arranged at the lower right, respectively. Furthermore, by arranging the Ye-component filter respectively on the upper left and the lower right, the R-component filter and the W-component filter may be switched with each other.

In each of the above-described embodiments, the image sensor is a CCD. However, it is needless to say that the present invention is not limited to that. The image sensor may be MOS (Metal Oxide Semiconductor) type sensor.

Furthermore, although some of the functions as the image pickup device, such as flash, mechanical shutter, etc., have been omitted in the explanation, it should be noted that addition of the adherent functions is covered within the range of the present invention.

The present invention has been described in detail with respect to the most preferred embodiments. However, various combinations and modifications of the components are possible without departing from the spirit and the broad scope of the appended claims.

What is claimed is:

1. An image input device, comprising
a solid-state image pickup element for picking up a subject, and
a signal processor for signal-processing an image pickup signal outputted from said solid-state image pickup element, wherein:
said solid-state image pickup element comprises a filter film made of a single-layer inorganic material which exhibits maximum value at a specific wavelength on transmission spectra of incident light in accordance with a film thickness, and a photoelectrical conversion part for generating a signal charge in accordance with light quantity of said incident light transmitted through said filter film, wherein a number of said filter films of at least two kinds with different film thickness is provided, and said number of filter films are arranged in parallel based on a prescribed arrangement; and
said signal processor generates at least one of the signals that correspond to a luminance signal, a color signal, a color difference signal, and light quantity of incident light by applying color conversion processing on said image pickup signal in accordance with said prescribed arrangement.

2. The image input device according to claim 1, comprising a number of three kinds of filter films having a different film thickness from each other, and said filter films are arranged in parallel based on an array unit of two lines in two columns, wherein:
said filter films having a first film thickness and a third film thickness are arranged in order in a first column of said array unit; and said filter film shaving a second film thickness and said first film thickness are arranged in order in a second column of said array unit.

3. The image input device according to claim 2, wherein said first film thickness, said second film thickness, and said third film thickness are set to be thicker in order of said second film thickness, said first film thickness, and said third film thickness.

4. The image input device according to claim 1, comprising a number of four kinds of filter films having a different film thickness from each other, and said filter films are arranged in parallel based on an array unit of two lines in two columns, wherein:
said filter films having a first film thickness and a second film thickness are arranged in order in a first column of said array unit; and said filter films having a third film thickness and a fourth film thickness are arranged in order in a second column of said array unit.

5. The image input device according to claim 1, comprising a number of four kinds of filter films having a different film thickness from each other, and said filter films are arranged in parallel based on an array unit of four lines in two columns, wherein:
said filter films having a first film thickness, a second film thickness, said first film thickness, and a fourth film thickness are arranged in order in a first column of said array unit; and said filter films having a third film thickness, said fourth film thickness, said third film thickness, and said second film thickness are arranged in order in a second column of said array unit.

6. The image input device according to claim 1, comprising a number of four kinds of filter films having a different film thickness from each other, and said filter films are arranged in parallel based on an array unit of four lines in two columns, wherein:
said filter films having a first film thickness, a second film thickness, a third film thickness, and a fourth film thickness are arranged in order in a first column of said array unit; and said filter films having said third film thickness, said fourth film thickness, said first film thickness, and said second film thickness are arranged in order in a second column of said array unit.

7. The image input device according to claim 1, wherein:
said image pickup signal includes 1st to n-th image pickup signal (n is a natural number of 2 or more), which are generated through performing photoelectrical conversion processing on incident light transmitting through 1st to n-th said filter films having a different film thickness from each other, by said photoelectrical conversion part; and
said signal processor executes color conversion processing expressed by adding or subtracting a constant with respect to a linear primary combination expression of said 1st to n-th image pickup signals.

8. The image input device according to claim 7, wherein said signal processor generates said luminance signal by executing said color conversion processing that multiplies a first constant and adds or subtracts a second constant on one kind of said 1st to n-th image pickup signals.

9. The image input device according to claim 1, wherein said signal processor executes said color conversion processing in which second differential value of said gamma correction function is expressed as 0 or more in an area where an input is smaller than a prescribed threshold value, and second differential value of said gamma correction function is expressed as 0 or less in an area where an input is larger than said prescribed threshold value, regarding shape of gamma correction function in said signal-processing.

10. The image input device according to claim 1, wherein said signal processor executes said color conversion processing in which second differential value of said gamma correction function is expressed as 0 or more, regarding shape of gamma correction function.

11. The image input device according to claim 1, wherein said signal processor executes said color conversion processing in which shape of gamma correction function is expressed with a linear function and a combination of the linear functions.

12. The image input device according to claim 1, wherein said color conversion processing includes processing for eliminating a noise component.

13. The image input device according to claim 1, wherein said color conversion processing includes processing for transmitting only a signal of less than a prescribed band of a color difference signal in a frequency component.

14. The image input device according to claim 13, wherein said prescribed band is lower than a band of a luminance signal.

15. The image input device according to claim 1, wherein said solid-state image pickup element comprises an IR cut filter on a path of the incident light for eliminating near infrared rays.

16. A solid-state image pickup element, comprising
a filter film which exhibits different maximum values from each other for at least three wavelengths on transmission spectra of incident light, and
a photoelectrical conversion part for generating a signal charge in accordance with light quantity of said incident light transmitted through said filter film, wherein
said wavelengths are included in a wave range of 650 nm-750 nm, a wave range of 525 nm-625 nm, and a wave range of 380 nm-480 nm.

17. The solid-state image pickup element according to claim 16, wherein said wavelengths are 700 nm, 575 nm, and 435 nm, respectively.

18. The solid-state image pickup element according to claim 16, wherein said filter film is made of a single-layer inorganic material that exhibits a maximum value at a specific wavelength of said transmission spectra of said incident light in accordance with its film thickness.

19. The solid-state image pickup element according to claim 16, wherein said filter film comprises a filter film having a film thickness of 65-100 nm, a filter film having a film thickness of 50-70 nm, and a filter film having a film thickness of 30-50 nm, wherein said filter films are arranged in parallel based on a prescribed arrangement, wherein
film thicknesses of said filter films are set according to correlation between refractive index thereof and wavelengths that exhibit said maximum values.

20. The solid-state image pickup element according to claim 16, wherein said three kinds of filter films are arranged in parallel based on an array unit of two lines in two columns, wherein:
said filter film with said maximum value within a range of 650 nm-750 nm and said filter film with said maximum value within a range of 525 nm-625 nm are arranged in order in a first column of said array unit; and
said filter film with said maximum value within a range of 525 nm-625 nm and said filter film with said maximum value within a range of 380 nm-480 nm are arranged in order in a second column of said array unit.

21. A solid-state image pickup element, comprising
a filter film with a transmission characteristic for transmitting light of at least three wavelengths on transmission spectra of incident light, and
a photoelectrical conversion part for generating a signal charge in accordance with light quantity of said incident light transmitted through said filter film, wherein
said wavelengths include 650 nm or more, 525 nm or more, and 380 nm or more.

22. The solid-state image pickup element according to claim 21, wherein said filter film exhibits the maximum values in wavelength ranges of 650 nm-750 nm, 525 nm-625 nm, and 380 nm-480 nm.

23. The solid-state image pickup element according to claim 21, wherein said wavelengths include less than 700 nm, less than 575 nm, and less than 435 nm.

24. The solid-state image pickup element according to claim 21, wherein said filter film is made of a single-layer inorganic material with different film thickness.

25. The solid-state image pickup element according to claim 21, wherein said filter film comprises a filter film having a film thickness of 65-100 nm, a filter film having a film thickness of 50-70 nm, and a filter film having a film thickness of 30-50 nm, wherein said filter films are arranged in parallel based on a prescribed arrangement, wherein
film thicknesses of said filter films are set according to correlation between refractive index thereof and wavelengths that exhibit said maximum values on transmission spectra of said filter film.

26. The solid-state image pickup element according to claim 21, wherein said filter films are arranged in parallel based on an array unit of two lines in two columns, wherein
said filter film having said maximum value on said transmission spectra of said filter film within a range of 650 nm-750 nm and said filter film having a cutoff specific wavelength within a range of 525 nm-625 nm are arranged in order in a first column of said array unit, and
said filter film having said cutoff specific wavelength within a range of 525 nm-625 nm and said filter film having said maximum value within a range of 380 nm-480 nm are arranged in order in a second column of said array unit.

27. An image input device, comprising said solid-state image pickup element according to claim 20 and a signal processor for signal-processing an image pickup signal that is outputted from said solid-state image pickup element, wherein
said signal processor generates at least one of the signals that correspond to a luminance signal, a color signal, a color difference signal and light quantity of incident light by applying color conversion processing on said image pickup signal according to said array unit.

28. An image input device, comprising said solid-state image pickup element according to claim 26 and a signal processor for signal-processing an image pickup signal that is outputted from said solid-state image pickup element, wherein
said signal processor generates at least one of the signals that correspond to a luminance signal, a color signal, a color difference signal and light quantity of incident light by applying color conversion processing on said image pickup signal according to said array unit.
